(19) United States
(12) Patent Application Publication
(10) Pub. No.: US 2026/0152361 A1
(43) Pub. Date: Jun. 4, 2026

(54) MEDIUM PROCESSING APPARATUS AND IMAGE FORMING SYSTEM

(71) Applicant: Takuma YAZAKI, Gifu (JP)

(72) Inventor: Takuma YAZAKI, Gifu (JP)

(73) Assignee: ETRIA Co., Ltd., Kanagawa (JP)

(21) Appl. No.: 19/402,185

(22) Filed: Nov. 26, 2025

(30) Foreign Application Priority Data
Nov. 29, 2024 (JP) 2024-208949
Jul. 24, 2025 (JP) 2025-124189

(51) Int. Cl. B65H 37/04; B41J 29/17

(52) U.S. Cl. CPC B65H 37/04; B41J 29/17; B65H 2301/5126

(57) ABSTRACT

A medium processing apparatus includes a crimper and circuitry. The crimper includes a crimping teeth pair and a remover. The crimping teeth pair faces each other to press and deform a part of a media bundle bundling multiple media including a medium to perform a crimp-binding operation. The remover removes the medium attached to one of the crimping teeth pair. The circuitry is to move the crimper to a binding position in a scanning direction to perform the crimp-binding operation, control the remover to remove the medium from the one of the crimping teeth pair to perform a first removing operation, and control the crimper to remove the medium attached to the remover to perform a second removing operation.

### CROSS-REFERENCE TO RELATED APPLICATIONS

This patent application is based on and claims priority pursuant to 35 U.S.C. § 119(a) to Japanese Patent Application Nos. 2024-208949, filed on Nov. 29, 2024, and 2025-124189, filed on Jul. 24, 2025, in the Japan Patent Office, the entire disclosure of each of which is hereby incorporated by reference herein.

### BACKGROUND

### Technical Field

The present disclosure relates to a medium processing apparatus and an image forming system.

### Related Art

Various types of medium processing apparatuses are known that bind a sheet bundle of stacked sheet media. Such medium processing apparatuses employ binding processes including, for example, a “stapling process” for penetrating staple members (binding members) through a sheet bundle to bind the sheet bundle and a “crimp binding process” for pressing and deforming a part of a sheet bundle to bind the sheet bundle.

A medium processing apparatus in the art has a configuration for removing a medium adhered to binding teeth for pressing and deforming a medium, regarding a liquid application crimp-binding apparatus for applying liquid to a medium in a crimp binding process.

In the configuration disclosed in the medium processing apparatus in the art, in the case of a removing mechanism integrated as a unit with respect to binding teeth and adjacent to the binding teeth, the disadvantage that the sheet adheres to the removing mechanism for removing cannot be solved. When the medium adheres to the removing mechanism, there is a disadvantage that the alignment accuracy of a media bundle decreases due to the removing. Alternatively, there is a disadvantage that the medium is deformed or damaged, which causes a decrease in binding quality of the media bundle.

### SUMMARY

Embodiments of the present disclosure described herein provide a novel medium processing apparatus including a crimper and circuitry. The crimper includes a crimping teeth pair and a remover. The crimping teeth pair faces each other to press and deform a part of a media bundle bundling multiple media including a medium to perform a crimp-binding operation. The remover removes the medium attached to one of the crimping teeth pair. The circuitry is to move the crimper to a binding position in a scanning direction to perform the crimp-binding operation, control the remover to remove the medium from the one of the crimping teeth pair to perform a first removing operation, and control the crimper to remove the medium attached to the remover to perform a second removing operation.

Further, embodiments of the present disclosure described herein provide an image forming system including an image forming apparatus to form an image on a medium of multiple media, and the above-described medium processing apparatus to perform the crimp-binding operation on the multiple media having the image formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment;

FIG. 3 is a schematic view of an edge binder viewed from an upstream side in a conveyance direction;

FIG. 4 is a schematic view of an edge binder viewed from the side on which a liquid applier is located in a main scanning direction;

FIGS. 5A and 5B are schematic diagrams each illustrating a configuration of a crimper of the edge binder of FIG. 3;

FIG. 6 is a diagram illustrating an edge binder according to a modification;

FIGS. 7A, 7B, and 7C are diagrams each illustrating a liquid application crimper of the edge binder of FIG. 6;

FIGS. 8A, 8B, and 8C are diagrams each illustrating a liquid applying operation and a crimp binding operation performed by the liquid application crimper of FIGS. 7A, 7B, and 7C;

FIG. 9 is a schematic view of a staple binder viewed from the upstream side in the conveyance direction;

FIG. 10 is a schematic view of a modification of the staple binder as viewed from the upstream side in the conveyance direction;

FIGS. 11A and 11B are diagrams illustrating a location and configuration of a second liquid storage tank in the post-processing apparatus;

FIG. 12 including FIGS. 12A, 12B and 12C is a diagram illustrating a configuration of attachment and detachment of the second liquid storage tank in a post-processing apparatus;

FIG. 13 is a hardware configuration of a control block to control the post-processing apparatus according to the first embodiment;

FIG. 14 is a flowchart of a binding process performed by the edge binder;

FIGS. 15A, 15B, 15C, and 15D are diagrams illustrating positions of the edge binder during operation of a one-point binding;

FIGS. 16A, 16B, 16C, 16D, 16E, 16F, 16G, and 16H are diagrams illustrating positions of the edge binder during execution of a two-point binding;

FIG. 17 is a diagram illustrating an example of a crimper integrally including a sheet removing mechanism according to the present embodiment;

FIG. 18 is a diagram illustrating an example of a remover integrally provided in the crimper;

FIG. 19 is a diagram for describing an outline of an operation of the remover;

FIG. 20 is a diagram for describing an outline of an operation of the sheet removing mechanism;

FIG. 21 is a perspective view for describing an outline of an operation of the sheet removing mechanism;

FIG. 22 is a diagram for describing a relationship between crimping teeth included in the crimper and the remover;

FIG. 23 is a flowchart of a binding process by an edge binder including a sheet removing mechanism;

FIGS. 24A and 24B are diagrams for describing a first example of the operation of the sheet removing mechanism;

FIGS. 25A and 25B are diagrams for describing a second example of the operation of the sheet removing mechanism;

FIG. 26 is a diagram for describing Modification 1 of the remover;

FIG. 27 is a diagram for describing Modification 2 of the remover;

FIG. 28 is another example of a flowchart of a binding process by an edge binder including a sheet removing mechanism;

FIG. 29 is a diagram illustrating an internal structure of a post-processing apparatus according to a second embodiment;

FIGS. 30A, 30B, and 30C are schematic views of an internal tray according to the second embodiment, viewed from a thickness direction of a sheet;

FIG. 31 is a schematic view of a crimper according to the second embodiment, viewed from a downstream side in a conveyance direction;

FIGS. 32A and 32B are views of a liquid applier according to the second embodiment, viewed from a thickness direction of a sheet;

FIGS. 33A, 33B, and 33C are cross-sectional views of the liquid applier, taken along line XXV-XXV of FIG. 32A;

FIGS. 34A, 34B, and 34C are cross-sectional views of the liquid applier, taken along line XXVI-XXVI of FIG. 32A;

FIG. 35 is a hardware configuration diagram of a control block of the post-processing apparatus according to the second embodiment;

FIG. 36 is a flowchart of post-processing of the post-processing apparatus according to the second embodiment;

FIG. 37 is a diagram illustrating an overall configuration of an image forming system according to a modification;

FIGS. 38A and 38B are diagrams illustrating Modification 1 of a controller of the post-processing apparatus; and

FIGS. 39A and 39B are diagrams illustrating Modification 2 of a controller of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Referring now to the drawings, embodiments of the present disclosure are described below. As used herein, the singular forms “a,” “an,” and “the” are intended to include the plural forms as well, unless the context clearly indicates otherwise.

### Embodiment of Image Forming System

A description is given of an image forming system 1 according to an embodiment of the present disclosure, with reference to the drawings.

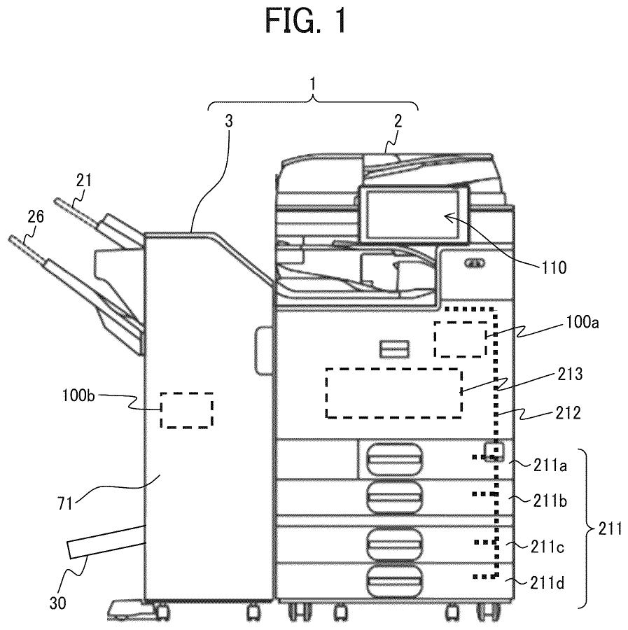

FIG. 1 is a diagram illustrating an overall configuration of the image forming system 1 according to the embodiment of the present disclosure.

The image forming system 1 has a function of forming an image on a sheet as a sheet medium and a function of performing a post-processing operation on the sheet as a process after the image is formed on the sheet. As illustrated in FIG. 1, the image forming system 1 includes an image forming apparatus 2 including the image forming function and a post-processing apparatus 3 serving as a medium processing apparatus including the post-processing function, according to an embodiment of the present disclosure. In the image forming system 1, the image forming apparatus 2 and the post-processing apparatus 3 operate in conjunction with each other.

In the present embodiment, the sheet-shaped medium to be processed in the image forming system 1 is described on the assumption that the medium is a sheet of “paper”. However, the object to be processed according to the present embodiment is not limited to a sheet of paper. For example, any material or specification may be used as long as an image can be formed on a medium in a known image forming process and the medium is a target of the image forming process. Examples of the medium include a medium that can be an object of a folding process or a binding process, and the material and specification of the medium are not limited to any particular material and specification.

The image forming apparatus 2 forms an image on a sheet (medium) and ejects the sheet having the image to the post-processing apparatus 3. The image forming apparatus 2 includes sheet trays 211 (211a, 211b, 211c, and 211d) that accommodate the sheets, a conveyor 212 that conveys the sheet accommodated in the sheet tray 211, and an image former 213 that forms an image on the sheet conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration is omitted.

Sheets of paper are widely known as an example of sheet-shaped media. Further, in the following description, a sheet-shaped medium as a medium to be processed is referred to as a “sheet P”. In the following description, a bundle of sheets of paper as multiple media is an example of a “sheet bundle Pb”.

### First Embodiment of Post-Processing Apparatus

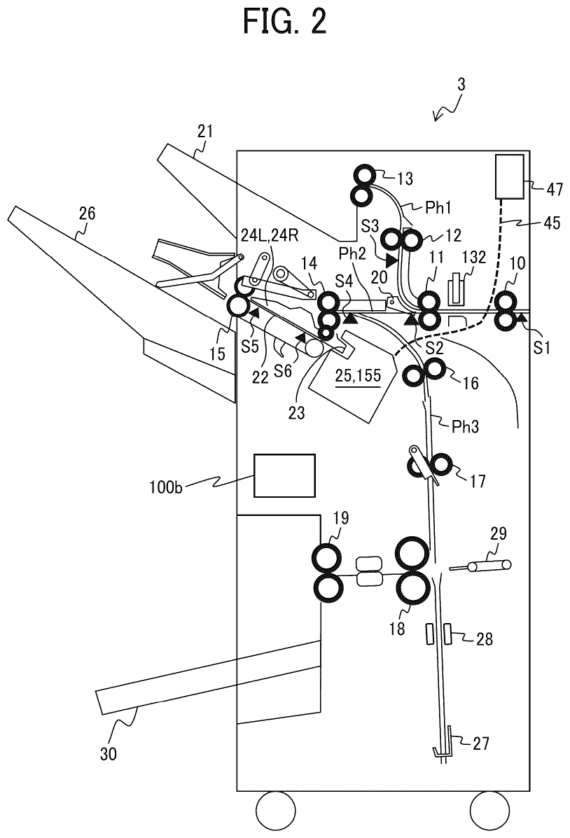

FIG. 2 is a diagram illustrating an internal configuration of the post-processing apparatus 3 according to the first embodiment of the present disclosure.

The post-processing apparatus 3 has a function that performs given post-processing on the sheet P on which an image is formed by the image forming apparatus 2. An example of the post-processing according to the present embodiment is a “crimp binding operation” of binding a bundle of multiple sheets P on which an image is formed as a media bundle (referred to as “sheet bundle Pb”) without staples. Another example of the post-processing according to the present embodiment is a “stapling process” of binding a sheet bundle Pb as a media bundle with staples.

In the present embodiment, a description is given mainly of a liquid application process in a crimp binding operation. However, the liquid application related to a stapling process is similar to the liquid application in the crimp binding process. In the following description, the term “binding process” indicates both the “crimp binding operation” and the “stapling process”, and is not limited to a binding method (whether binding is performed using staples or binding is performed by pressing and deforming without staples).

More particularly, the “crimp binding operation” according to the present embodiment is a process of applying pressure to a binding position corresponding to a part of the sheet bundle Pb to deform the binding position by a crimper 32, and entangling fibers of the overlapping sheets P to bind the sheets P together. The crimp binding operation partially binds the overlapping portions of the sheets P together to form a sheet bundle Pb. This crimp binding operation is referred to as “crimp binding” in the following description. The binding process (including both crimp binding and stapling) that is executable by the post-processing apparatus 3 includes an edge binding process of binding the edge of the sheet bundle Pb and a saddle binding process of binding the central portion of the sheet bundle Pb.

The post-processing apparatus 3 includes conveyance roller pairs 10 to 19 as a conveyor and a switcher 20.

The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance passage Ph1. The conveyance roller pairs 14 and 15 convey the sheet P along a second conveyance passage Ph2. Further, the conveyance roller pairs 16 to 19 convey the sheet P along a third conveyance passage Ph3. A hole punch 132 is disposed between the conveyance roller pair 10 and the conveyance roller pair 11. The hole punch 132 performs punching on a sheet P conveyed by the conveyance roller pair 10 and the conveyance roller pair 11. The post-processing apparatus 3 further includes a controller 100b as a controller or circuitry. The controller 100b controls the operation of driving members in the post-processing apparatus 3 such as the conveyance roller pairs 10 to 19 and the switcher 20, and acquires detection results from various sensors as a detector. Details of the controller 100b will be described below.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pair 11 and the conveyance roller pair 14 in a conveyance direction of the sheet and extending to a second ejection tray 26 via an internal tray 22. The third conveyance passage Ph3 is a passage branching from the first conveyance passage Ph1 between the conveyance roller pair 11 and the conveyance roller pair 14 in the conveyance direction and extending to an ejection tray 30.

The switcher 20 is disposed at a branching position of the first conveyance passage Ph1 and the second conveyance passage Ph2. The switcher 20 can be switched between a first position and a second position. The switcher 20 in the first position guides the sheet P to be ejected to the first ejection tray 21 through the first conveyance passage Ph1. The switcher 20 in the second position guides the sheet P conveyed through the first conveyance passage Ph1 to the second conveyance passage Ph2. The conveying roller pair 14 is rotated in reverse at the timing when the trailing edge of the sheet P that has entered the second conveyance passage Ph2 passes through the branching position of the second conveyance passage Ph2 and the third conveyance passage Ph3. Thus, the sheet P is guided to the third conveyance passage Ph3. The post-processing apparatus 3 further includes multiple sensors S1 to S6 that detect the positions of the sheet P in the first conveyance passage Ph1, the second conveyance passage Ph2, and the third conveyance passage Ph3. Each of the multiple sensors S1 to S6 is indicated by a black triangle in FIG. 2.

The post-processing apparatus 3 includes a first ejection tray 21. The sheet P that is ejected through the first conveyance passage Ph1 is placed on the first ejection tray 21. Among the sheets P supplied from the image forming apparatus 2, a sheet P not subjected to the binding process is ejected to the first ejection tray 21.

The post-processing apparatus 3 further includes the internal tray 22 serving as a stacker on which a sheet P or a sheet bundle Pb is placed, an edge binding end fence 23, side fences 24L and 24R, an edge binder 25, a staple binder 155, and the second ejection tray 26. The internal tray 22, the edge binding end fence 23, the side fences 24L and 24R, the edge binder 25, and the staple binder 155 perform the edge binding process on the sheet bundle Pb including multiple sheets P conveyed from the second conveyance passage Ph2 to the internal tray 22. Among the sheets P supplied from the image forming apparatus 2, the sheet bundle Pb subjected to the edge binding process is ejected to the second ejection tray 26.

The “edge binding process” here represents a binding process performed by the edge binder 25 and the staple binder 155. Specifically, the “edge binding process” includes, but is not limited to, a “parallel binding process” that binds the sheet bundle Pb along one side of the sheet bundle Pb parallel to a main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge binding end fence 23 is defined as a “conveyance direction”. In other words, the “conveyance direction” in the present specification corresponds to a direction in which the sheet P ejected from the image forming apparatus 2 is moved toward the second ejection tray 26 by, for example, the conveyance roller pair 10 and is then changed by the conveyance roller pair 15 to move toward the edge binding end fence 23 as a direction different from the direction toward the second ejection tray 26. A direction that is orthogonal to the conveyance direction and the thickness direction of the sheet P, in other words, the width direction of the sheet P is defined as a “main scanning direction”.

The multiple sheets P conveyed in order via the second conveyance passage Ph2 is temporarily stacked on the internal tray 22. The edge binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform the edge binding process on the sheet bundle Pb aligned by the edge binding end fence 23 and the side fences 24L and 24R. The conveyance roller pair 15 ejects the sheet bundle Pb subjected to the edge binding process to the second ejection tray 26.

The post-processing apparatus 3 further includes a saddle binding end fence 27, a saddle binder 28, a sheet folding blade 29, and the ejection tray 30. The saddle binding end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the ejection tray 30.

The saddle binding end fence 27 aligns the positions, in the conveyance direction, of the multiple sheets P sequentially conveyed through the third conveyance passage Ph3. The saddle binding end fence 27 is movable in a direction in which the sheet P is conveyed toward the saddle binding end fence 27 and a reverse direction (vertical direction in FIG. 2) so that the center of the sheet bundle Pb is positioned at a binding position facing the saddle binder 28 and a folding position facing the sheet folding blade 29. The saddle binder 28 binds the center of the sheet bundle Pb aligned by the saddle binding end fence 27 at the binding position. The sheet folding blade 29 folds the sheet bundle Pb stacked on the saddle binding end fence 27 at the folding position in half and the conveyance roller pair 18 sandwiches the sheet bundle Pb. The conveyance roller pair 18 and the conveyance roller pair 19 eject the sheet bundle Pb subjected to the saddle binding process to the ejection tray 30.

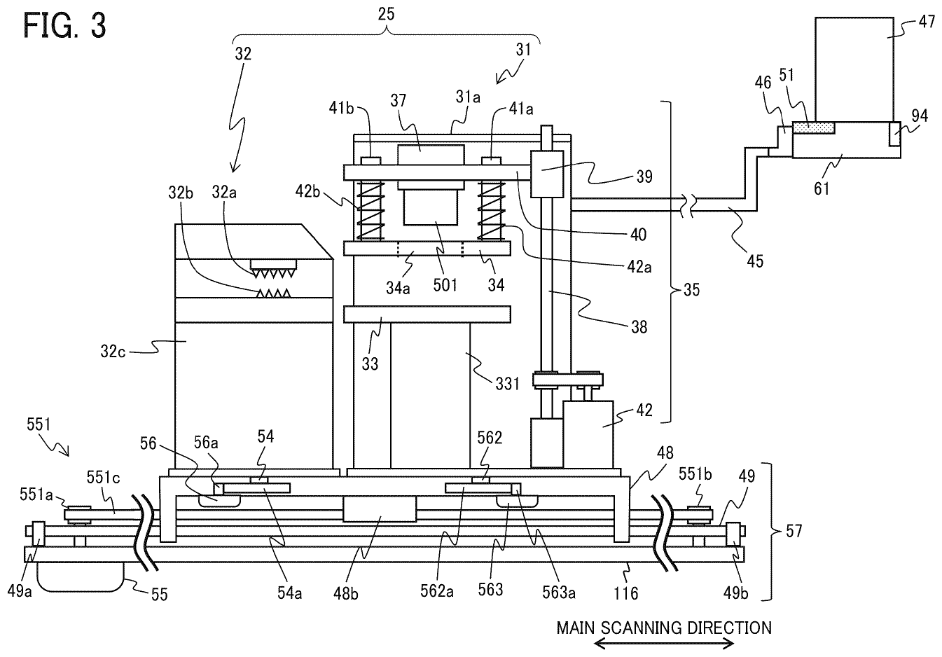

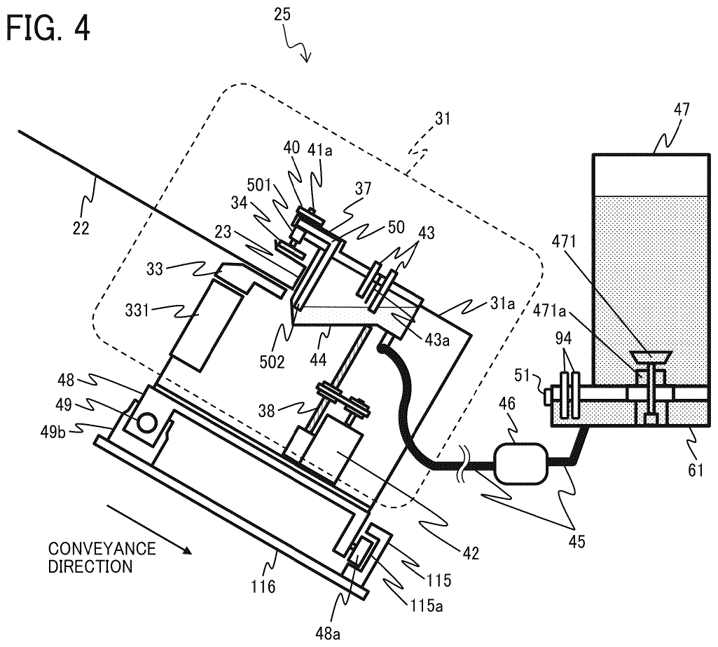

As illustrated in FIGS. 3 and 4 to be described below, the post-processing apparatus 3 includes a liquid application member 501 and a liquid supply member 50 as a part of the liquid applier and a first liquid storage tank 44 as a first liquid storage unit in the end binder 25. The post-processing apparatus 3 includes a liquid supply passage 455, a liquid pump 46 as a liquid supplier, a second liquid storage tank 47 as a part of the second liquid storage, and a second liquid storage tank fixer 61 as a configuration for replenishing the first liquid storage tank 44 with liquid. The liquid that is stored in the second liquid storage tank 47 (referred to as “liquid in the second liquid storage tank 47”) is supplied to the first liquid storage tank 44 through the second liquid storage tank fixer 61, the liquid pump 46, and the liquid supply passage 45.

### Configuration of Edge Binder

FIG. 3 is a schematic diagram illustrating an upstream side of the edge binder 25 in the conveyance direction. The edge binder 25 performs liquid application and crimping illustrated in FIG. 2.

FIG. 4 is a schematic diagram illustrating a liquid applier 31 of the edge binder 25 when viewed from the main scanning direction.

As illustrated in FIG. 3, the edge binder 25 includes the liquid applier 31 that applies liquid to the sheet P or the sheet bundle Pb, and a crimper 32 that is an example of a post-processing device and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 (referred to as “liquid in the first liquid storage tank 44”) to the sheet P or the sheet bundle Pb placed on the internal tray 22. In the following description, applying liquid to a sheet P or a sheet bundle Pb by the liquid applier 31 and the operation of the liquid applier 31 when applying liquid are referred to as “liquid application”. The liquid applying operation of the liquid applier 31 accompanied by the control process is referred to as a “liquid application process”.

The liquid that is stored in the first liquid storage tank 44 as liquid for the “liquid application” includes, as a main component, the liquid state of a compound of hydrogen and oxygen represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid that is stored in the liquid storage tank may include residual chlorine used as tap water. Preferably, for example, the liquid that is stored in the liquid storage tank may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

### Configuration of Liquid Applier

As illustrated in FIGS. 3 and 4, the liquid applier 31 can be moved in the main scanning direction together with the crimper 32 by the driving force transmitted from the edge binder movement motor 55.

The liquid applier 31 includes a lower pressure plate 33 as a sheet stacking table of the sheet P or the sheet bundle Pb, an upper pressure plate 34, and a liquid applier movement assembly 35. For example, the lower pressure plate 33, the upper pressure plate 34, the liquid applier movement assembly 35, and a liquid applier movement motor 42 as components of the liquid applier 31 are held by at least one of a liquid application frame 31a or a base 48.

A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction”.

In the upper pressure plate 34, a through hole 34a penetrating in the thickness direction is formed. The through hole 34a is provided at a position facing the liquid application member 501 held via a holder 37 attached to the base plate 40. As described below, the liquid application member 501 is provided at a first end of the liquid supply member 50 as a liquid absorber. The liquid application member 501 applies the liquid to the sheet P or the sheet bundle Pb by coming into contact with the sheet P or the sheet bundle Pb through the through hole 34a. The liquid application member 501 is the first end of the liquid supply member 50 as a liquid absorber and corresponds to a tip portion of the liquid supply member 50. Details of the liquid supply member 50 will be described below.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the embodiment moves the upper pressure plate 34, the base plate 40, the holder 37, the liquid application member 501, the liquid supply member 50, and the first liquid storage tank 44 together by the single liquid applier movement motor 42. The liquid applier movement assembly 35 includes, for example, the liquid applier movement motor 42, a trapezoidal screw 38, a nut 39, the base plate 40, columns 41a and 41b, and coil springs 42a and 42b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt.

The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

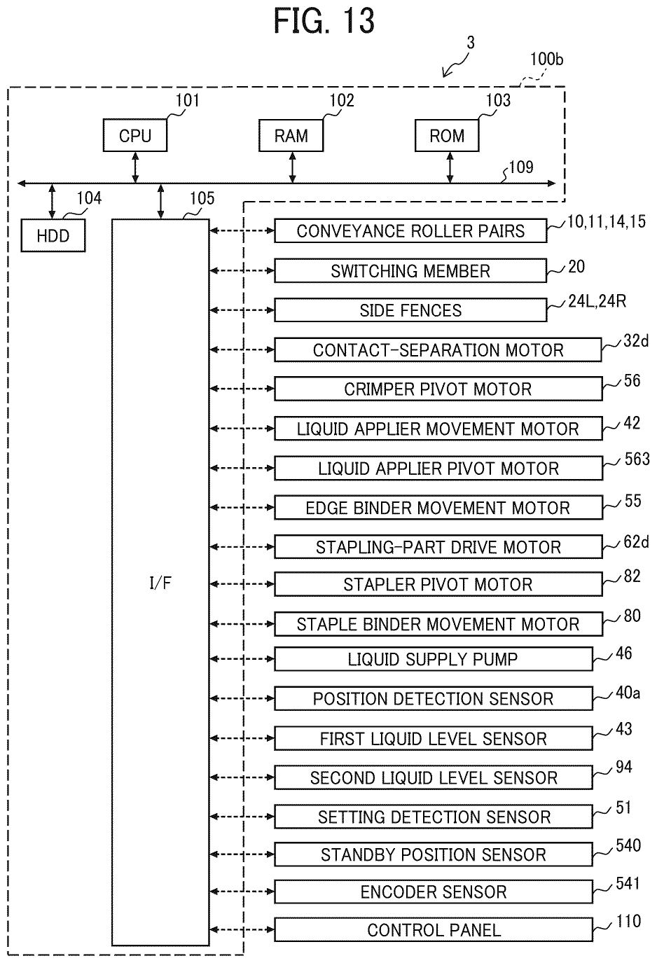

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 13).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers for preventing the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More particularly, the liquid applier 31 brings the liquid application member 501 into contact with the sheet P or the sheet bundle Pb to apply the liquid to at least one sheet P of the sheet bundle Pb.

The liquid applier 31 includes a first liquid level sensor 43 as a first liquid detector, the first liquid storage tank 44, the liquid application member 501, the liquid supply member 50, and the holder 37. The first liquid storage tank 44 stores the liquid for performing liquid application on the sheet P or the sheet bundle Pb. The liquid level in the first liquid storage tank 44, in other words, the amount of liquid stored in the first liquid storage tank 44 is detected by the first liquid level sensor 43. The first liquid storage tank 44 is coupled to the base plate 40 via the holder 37.

The liquid application member 501 applies the liquid in the first liquid storage tank 44 to the sheet P or the sheet bundle Pb. The liquid application member 501, the liquid supply member 50 as a liquid absorber disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid in the first liquid storage tank 44. In other words, the second end of the liquid supply member 50 corresponds to an immersion portion 502 that draws up the liquid and supplies the liquid to the liquid application member 501. The liquid application member 501 and the liquid supply member 50 are made of a material having a high liquid absorption rate (for example, sponge or fiber), such as an elastic resin formed of open cells. However, at least one of the liquid application member 501 or the liquid supply member 50 is not limited to a particular kind as long as the at least one of the liquid application member 501 or the liquid supply member 50 is made of a material having a property of absorbing and holding the liquid and has a property of being crushable in accordance with a pressing force applied when the at least one of the liquid application member 501 or the liquid supply member 50 is in contact with the sheet P or the sheet bundle Pb. In other words, the material may be any material as long as the material can absorb or draw up liquid by capillary action.

Accordingly, when the immersion portion 502 of the liquid supply member 50 is immersed in the liquid in the first liquid storage tank 44, the liquid supply member 50 sucks up the liquid by capillary action. In other words, the liquid in the first liquid storage tank 44 is sucked up from the immersion portion 502 of the liquid supply member 50, and the sucked liquid is supplied to the liquid application member 501 that is coupled to the tip portion via the liquid supply member 50. Then, the liquid in the first liquid storage tank 44 is sucked up by the liquid application member 501 in close contact with the first end of the liquid supply member 50, and thus the liquid level of the liquid in the first liquid storage tank 44 decreases. Then, the liquid level of the liquid in the first liquid storage tank 44 detected by the first liquid level sensor 43 decreases. When the first liquid level sensor 43 detects a decrease in the liquid level of the liquid in the first liquid storage tank 44, the supply of the liquid from the second liquid storage tank 47 to the first liquid storage tank 44 by the liquid pump 46 is started. The operation of supplying liquid from the second liquid storage tank 47 to the first liquid storage tank 44 by the liquid pump 46 is referred to as a “liquid supply operation”.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid in the first liquid storage tank 44. Accordingly, the liquid level of the liquid in the first liquid storage tank 44 temporarily decreases to a level below the reference liquid level described below. In response to this decrease of liquid in the first liquid storage tank 44, a liquid supply operation for feeding liquid from the second liquid storage tank 47 to the first liquid storage tank 44 is performed. This series of liquid supply operations is typically performed at the time of activation of the post-processing apparatus 3 or at the time of start of execution of the binding process involving liquid application in the post-processing apparatus 3, and corresponds to the liquid supply operations for bringing the liquid application using the liquid application member 501 to be executable.

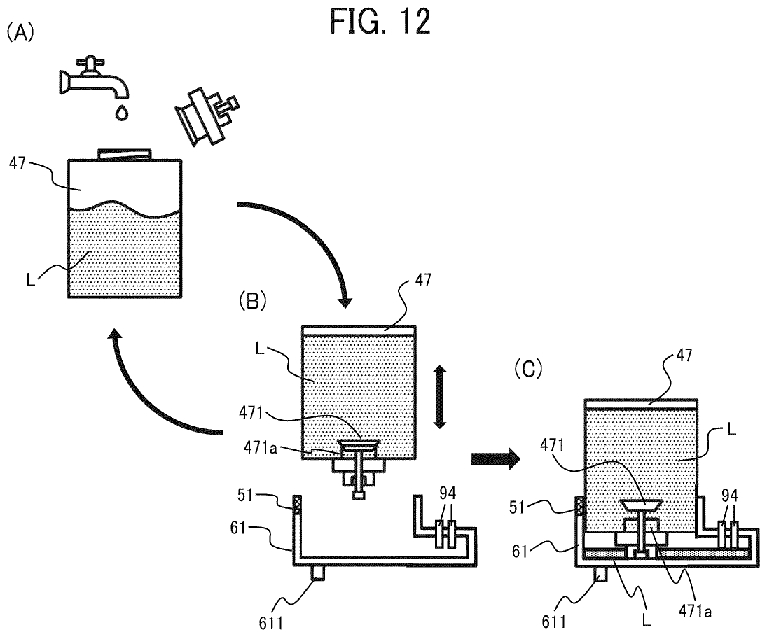

The edge binder 25 or the post-processing apparatus 3 is provided with the second liquid storage tank 47. The second liquid storage tank 47 is attachable to and detachable from the second liquid storage tank fixer 61 as a part of the second liquid storage provided in the edge binder 25 or the post-processing apparatus 3 (see FIGS. 12A to 12C). The second liquid storage tank fixer 61 may be provided in either the edge binder 25 or the post-processing apparatus 3. The second liquid storage tank 47 is set in a predetermined posture in the second liquid storage tank fixer 61, so that the liquid in the second liquid storage tank 47 can be supplied to the first liquid storage tank 44 via the second liquid storage tank fixer 61.

The operation to supply liquid from the second liquid storage tank 47 to the first liquid storage tank 44 by the liquid pump 46 is executed in response to a decrease in the reference liquid level in the first liquid storage tank 44. The liquid level of the liquid in the first liquid storage tank 44 is reduced by the liquid being consumed by the liquid application by the liquid applier 31. In other words, the operation of supplying liquid from the second liquid storage tank 47 to the first liquid storage tank 44 corresponds to the liquid supply operation needed with the execution of the binding process including the liquid application by the liquid applier 31.

This liquid supply operation corresponds to an operation of supplying liquid to the first liquid storage tank 44 so as to add liquid each time the liquid level of the liquid in the first liquid storage tank 44 falls below the reference liquid level, which is described below.

When the second liquid storage tank 47 is set in the second liquid storage tank fixer 61, the second liquid storage tank fixer 61 is filled with a certain amount of the liquid in the second liquid storage tank 47. The second liquid storage tank fixer 61 includes a setting detection sensor 51 as a set detector for detecting a set state of the second liquid storage tank 47 (see FIG. 12B). When the setting detection sensor 51 detects the set state of the second liquid storage tank 47 to the second liquid storage tank fixer 61 (see FIG. 12C), a signal indicating that the second liquid storage tank 47 is set on the second liquid storage tank fixer 61 is transmitted to the controller 100b, which is described below. Thus, the controller 100b detects whether the second liquid storage tank 47 is set on the second liquid storage tank fixer 61 based on a signal received from the setting detection sensor 51. Details of the second liquid storage tank 47 are described below.

The first liquid storage tank 44 and the second liquid storage tank 47 are connected to each other by the liquid supply passage 45. The liquid pump 46 is disposed near the second liquid storage tank fixer 61. As the liquid pump 46 is driven, the liquid in the second liquid storage tank 47 is supplied from the second liquid storage tank 47 to the first liquid storage tank 44 via the liquid supply passage 45. Accordingly, the second liquid storage tank fixer 61 is a component of the liquid supplier that executes a liquid supply operation to supply liquid from the second liquid storage tank 47 to the first liquid storage tank 44. The liquid supply passage 45 includes a flexible material. Accordingly, even if the first liquid storage tank 44 is moved by the liquid applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid level sensor 43. In other words, the controller 100b, which is described below, determines the liquid level of the liquid in the first liquid storage tank 44 based on the detection result of the first liquid level sensor 43.

In accordance with the determined liquid level of the first liquid storage tank 44, the controller 100b controls the operation speed and time of the liquid pump 46. Thus, the controller 100b can adjust the amount of liquid to be supplied from the second liquid storage tank 47 to the first liquid storage tank 44 to maintain the liquid level of the liquid in the first liquid storage tank 44 at a constant liquid level.

### Configuration of Crimper

As illustrated in FIG. 3, the crimper 32 as a post-processing device included in the edge binder 25 presses and deforms at least a portion, in other words, a liquid application position of the sheet bundle Pb, to which liquid has been applied by the liquid applier 31, by serrated upper crimping teeth 32a and serrated lower crimping teeth 32b, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding”. In other words, the crimper 32 crimps and binds the sheet bundle Pb or performs the crimp binding on the sheet bundle Pb. The crimp binding operation of the crimper 32 that involves control process is referred to as “crimp binding process”.

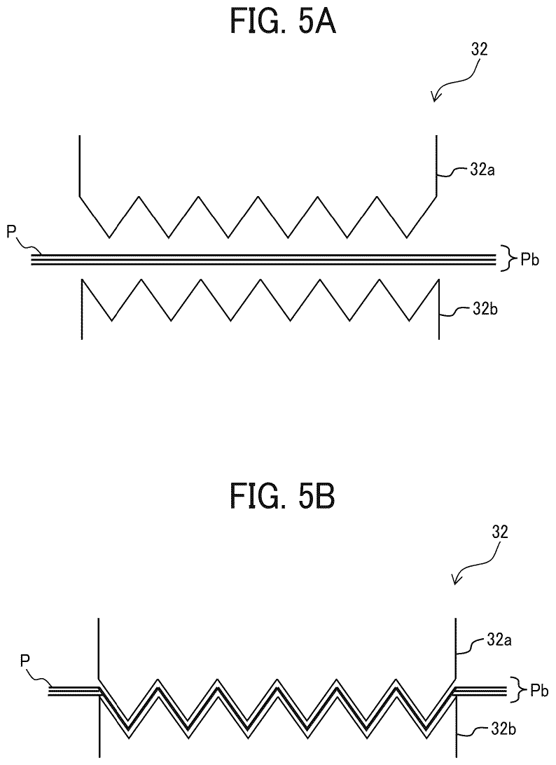

FIGS. 5A and 5B are schematic diagrams illustrating a configuration of the crimper 32.

As illustrated in FIGS. 5A and 5B, the crimper 32 includes the upper crimping teeth 32a and the lower crimping teeth 32b as a pair of crimping teeth or a crimping teeth pair. The upper crimping teeth 32a and the lower crimping teeth 32b are disposed to face each other in the thickness direction of the sheet bundle Pb so as to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The upper crimping teeth 32a and the lower crimping teeth 32b are formed in such a positional relationship that the concave portion and the convex portion are displaced so as to mesh with each other. The upper crimping teeth 32a and the lower crimping teeth 32b approach and move away from each other by the driving force of a contact-separation motor 32d illustrated in FIG. 13.

In the process of loading the sheets P of the sheet bundle Pb into the internal tray 22, the upper crimping teeth 32a and the lower crimping teeth 32b are separated from each other as illustrated in FIG. 5A. When the multiple sheets P of the sheet bundle Pb is all stacked on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of an operating assembly described in the present embodiment, and may be any other suitable structure in which the upper crimping teeth 32a and the lower crimping teeth 32b of the crimping assembly engage with each other.

For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates in the forward and backward directions (for example, the configuration disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57.

The edge binder movement assembly 57 moves the edge binder 25, in other words, the liquid applier 31 and the crimper 32, in the main scanning direction along a downstream end, in the conveyance direction, of the sheet P placed on the internal tray 22. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 13).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a and 49b disposed in the main scanning direction at a position on the upstream side of a binding assembly base 116 in the conveyance direction of the sheet P. The guide shaft 49, as illustrated in FIG. 3, is disposed to extend in the main scanning direction on the binding assembly base 116, and holds the base 48 to be movable in the main scanning direction. As illustrated in FIG. 4, the guide rail 115 is disposed in the downstream side of the binding assembly base 116 in the conveyance direction and extends in the main scanning direction. As illustrated in FIG. 4, the guide rail 115 has a fitting object portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servomotor. By using the servomotor, the edge binder 25 can be stopped at any target position without returning the edge binder 25 to the origin position every time the movement is performed. In other words, the edge binder movement motor 55 can stop the edge binder 25 at the target position, in other words, a first liquid application position B1, a first binding position B1, a second liquid application position B2, and a second binding position B2 to be described below without returning the edge binder 25 to the origin position (for example, a standby position HP to be described below) every movement.

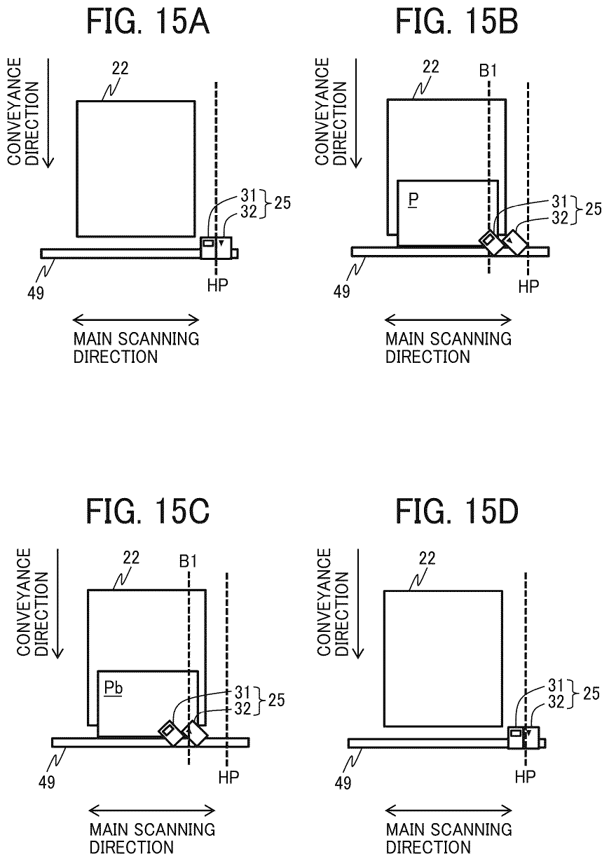

The post-processing apparatus 3 further includes a standby position sensor 540 and an encoder sensor 541. The standby position sensor 540 is, for example, a light-shielding optical sensor (see FIG. 13) to detect that the edge binder 25 has reached a standby position HP (see FIG. 15A). The encoder sensor 541 (see FIG. 13) is attached to an output shaft of the edge binder movement motor 55.

The standby position sensor 540 is, for example, a light shielding type optical sensor. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper rotary shaft 54 provided with a drive transmission gear 54a is fixed to a bottom face of the crimping frame 32c that holds the components of the crimper 32. The crimper rotary shaft 54 and the drive transmission gear 54a are held by a base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper rotary shaft 54 on the base 48 by a driving force transmitted from the crimper pivot motor 56 to the crimper rotary shaft 54 via the output gear 56a and the drive transmission gear 54a.

In the above description, although the edge binder 25 has a configuration of moving along the guide shaft 49 with the crimper 32 and the liquid applier 31 being integrated, the configuration of the edge binder is not limited to the above-described configuration. For example, the crimper 32 and the liquid applier 31 may have a configuration of moving separately from each other.

A description is given below of a modification of the edge binder 25 described above.

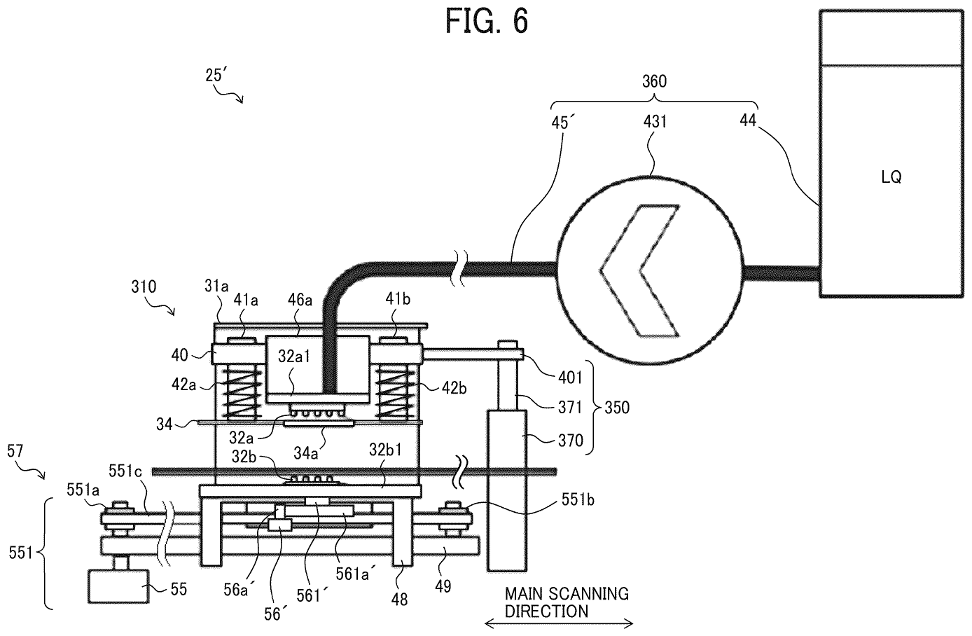

Specifically, referring now to FIGS. 6 to 8C, a description is given of an edge binder 25′ as a post-processing apparatus and as a modification of the edge binder 25 included in the post-processing apparatus 3. A difference of the edge binder 25′ from the edge binder 25 according to the first embodiment is that the liquid applier 31 and the crimper 32 are integrated as a single unit. In the following description, the same or like components as those of the edge binder 25 described above are denoted by the same or like reference numerals, and redundant descriptions thereof may be omitted.

FIG. 6 is a schematic diagram of the edge binder 25′ viewed from the upstream side in the conveyance direction.

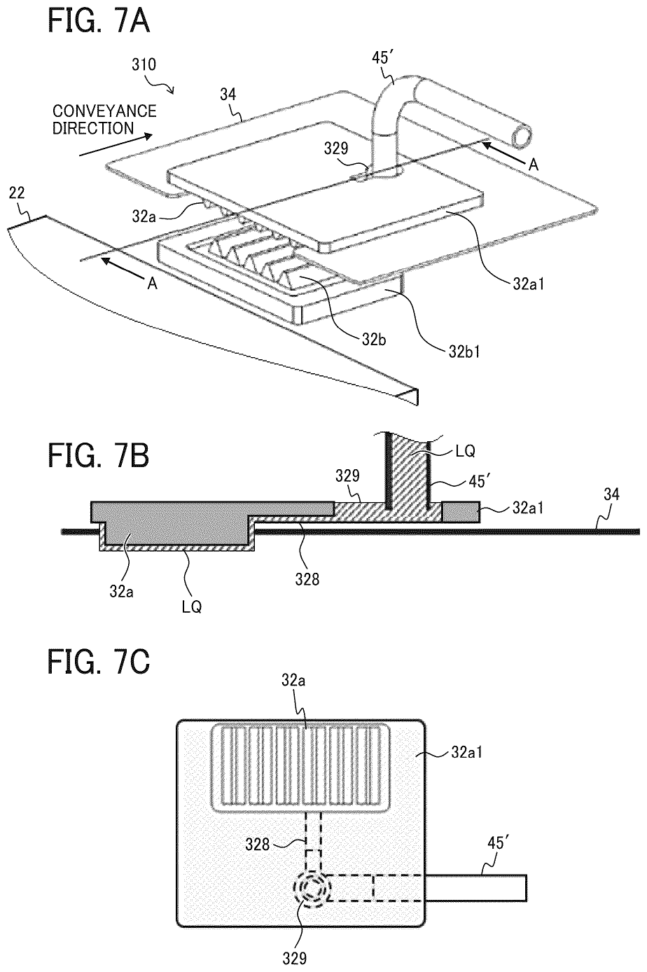

FIG. 7A is a perspective view of a liquid application crimper 310.

FIG. 7B is a view of the liquid application crimper 310 taken along line A-A in FIG. 7A.

FIG. 7C is a plan view of the upper crimping teeth 32a of FIG. 7A as viewed from the side at which the lower crimping teeth 32b is disposed.

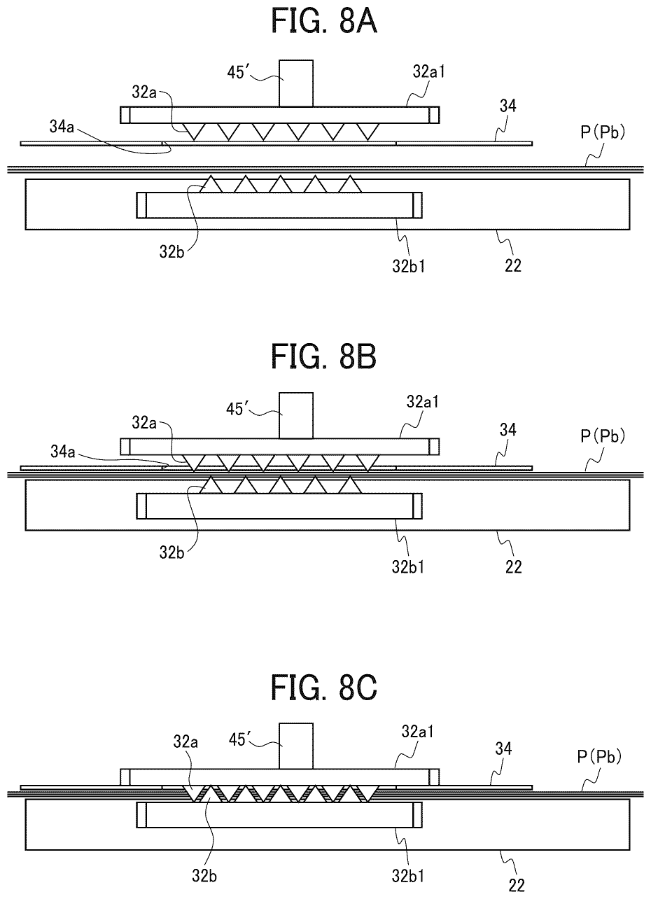

FIGS. 8A, 8B, and 8C illustrate a liquid applying operation and a crimp binding operation performed by the liquid application crimper 310 and are schematic views of the liquid application crimper 310 viewed from the downstream side in the conveyance direction.

As illustrated in FIG. 6, the edge binder 25′ includes the liquid application crimper 310 in which the liquid applier 31 and the crimper 32 of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 44 to a sheet P or a sheet bundle Pb placed on the internal tray 22. The liquid application crimper 310 can be moved in the main scanning direction by the driving force that is transmitted from the edge binder movement motor 55 to the base 48 by the driving force transmission assembly 551. The liquid application crimper 310 includes the upper pressure plate 34, the upper crimping teeth (upper binding teeth) 32a, the lower crimping teeth (lower binding teeth) 32b, a liquid application crimper movement assembly 350, and a liquid supply assembly 360. Components of the liquid application crimper 310 are held by at least one of the liquid application frame 31a or the base 48.

A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid application crimper pivot motor 56′. The liquid application crimper 310 can be rotated in the forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds an upper crimping teeth holder 32a1 and the upper crimping teeth 32a via a holder 46a. The base plate 40 movably holds the upper pressure plate 34 via the columns 41a and 41b. The base plate 40 is attached to an end of a rod 371 of the electric cylinder 370 through a coupler 401.

The columns 41a and 41b hold the upper pressure plate 34 at lower ends of the columns 41a and 41b. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid pump 431, and a liquid supply member 45′. The liquid pump 431 supplies the liquid to a liquid reservoir 329 disposed in the upper crimping teeth holder 32a1 as illustrated in FIG. 7A via the liquid supply member 45′. The liquid supply member 45′ has a proximal end connected to the liquid pump 431 and a leading end connected to the liquid reservoir 329, and is formed of a long and stretchable member.

As illustrated in FIG. 7B, the upper crimping teeth 32a are integrated with the upper crimping teeth holder 32a1. The upper crimping teeth holder 32a1 is provided with the liquid reservoir 329 and a liquid supply path 328 for supplying the liquid stored in the liquid reservoir 329 to the upper crimping teeth 32a. As illustrated in FIG. 7C, the surface of the upper crimping teeth 32a is subjected to a hydrophilic treatment so that the liquid LQ that is supplied through the liquid supply path 328 uniformly spreads over the surface of the upper crimping teeth 32a. On the other hand, the portion of the upper crimping teeth holding member 32a1 other than the upper crimping teeth 32a is subjected to a hydrophobic treatment so that the liquid LQ efficiently spreads over the surface of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

A description is given below of the liquid applying operation and the crimp binding operation of the liquid application crimper 310 with reference to FIGS. 8A, 8B, and 8C. In the process of loading a sheet P onto the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through hole 34a of the upper pressure plate 34 and come into contact with the sheet P. At this time, since the liquid LQ has spread over the surface of the upper crimping teeth 32a, the liquid is applied from the upper crimping teeth 32a in contact with the sheet P to the liquid application position on the sheet P. When liquid application to the liquid application position is completed, the electric cylinder 370 is extended to separate the upper crimping teeth 32a and the upper pressure plate 34 from the sheet P. The above-described contact and separation operation of the upper crimping teeth 32a and the upper pressure plate 34 with respect to the sheets P is repeatedly performed on sheets P of the sheet bundle Pb. In other words, the liquid applying operation by the liquid application crimper 310 is repeatedly executed.

When the sheet bundle Pb including a predetermined number of sheets P is placed on the internal tray 22, the electric cylinder 370 is further contracted to move the upper crimping teeth 32a from the liquid application position toward the lower crimping teeth 32b. Then, as illustrated in FIG. 8C, the upper crimping teeth 32a further move toward the lower crimping teeth 32b, with the sheet bundle Pb sandwiched between the upper crimping teeth 32a and the lower crimping teeth 32b. Thus, the upper crimping teeth 32a and the lower crimping teeth 32b press and deform the sheet bundle Pb to crimp and bind the sheet bundle Pb. In other words, the crimp binding operation by the liquid application crimper 310 is executed.

### Configuration of Staple Binder

Specifically, a detailed description is now given of the staple binder 155 having a function of executing a stapling process.

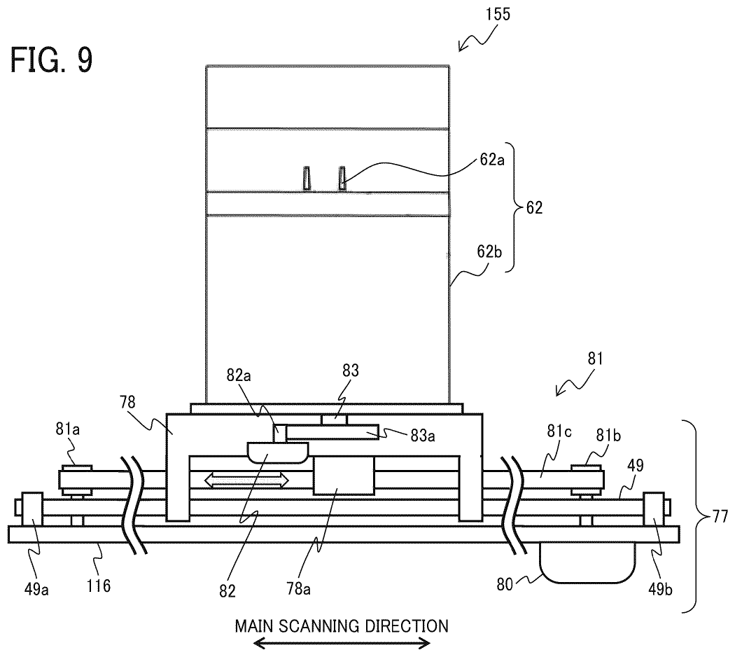

FIG. 9 is a schematic view illustrating the staple binder 155, viewed from the upstream side of the staple binder 155 in the conveyance direction.

The staple binder 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62, which is an example of a post-processing device, has a configuration of performing so-called “stapling” (i.e., stapling process) to bind the sheet bundle Pb with a staple or staples. More particularly, the stapler 62 includes a stapling-part drive motor 62d (see FIG. 13) that drives the stapling part 62a. The stapling part 62a binds the sheet bundle Pb by causing the binding staple loaded in the stapling part 62a to penetrate the sheet bundle Pb by the driving force of the stapling-part drive motor 62d. The configuration of the stapler 62 is already known, and thus detailed description thereof will be omitted.

As illustrated in FIG. 9, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

### Configuration of Modification of Staple Binder

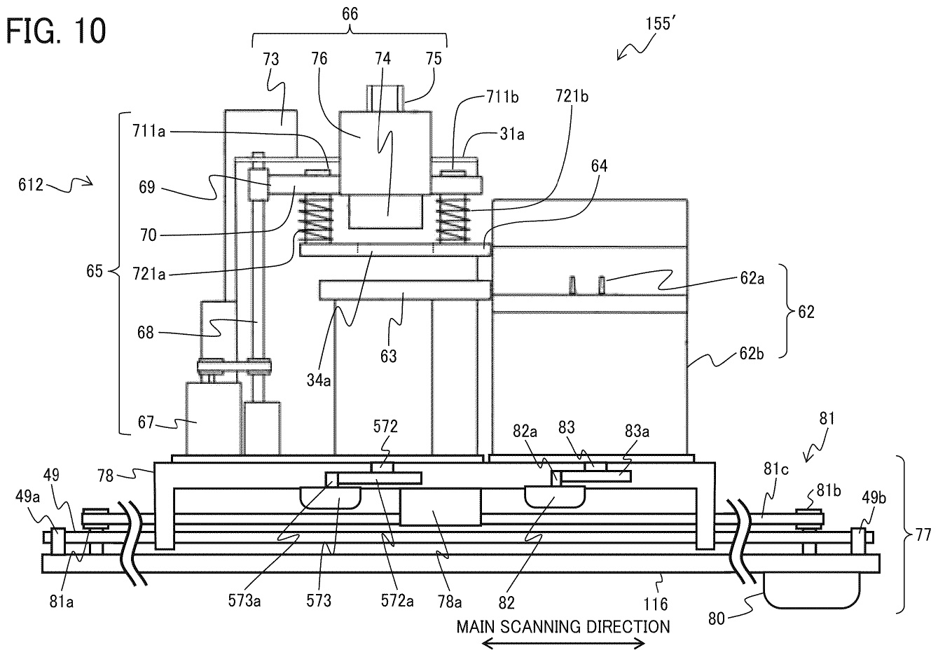

FIG. 10 illustrates a staple binder 155′ as a modification of the staple binder 155. Specifically, FIG. 10 is a view of an upstream side of the staple binder 155′ in the conveyance direction.

The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 performs the liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply member 75, a second liquid application member 74, and a second holder 76. Since the second liquid application assembly 66 and the liquid application assembly of the liquid applier 31 including the first liquid storage tank 44, the liquid supply member 50, the liquid application member 501, and the holder 37 described with reference to FIGS. 3 and 4 have common configurations, redundant descriptions thereof will be omitted. Since the stapler 62 has a configuration similar to the configuration of the staple binder 155 illustrated in FIG. 9, a detailed description thereof is omitted below unless otherwise required. Since the pivot mechanism of the second liquid applier 612 including the second liquid applier pivot motor 573, the second output gear 573a, the second drive transmission gear 572a, and the second liquid applier shaft 572 and the pivot mechanism of the liquid applier 31 including the liquid applier pivot motor 563, the output gear 563a, the drive transmission gear 562a, and the liquid applier shaft 562 illustrated in FIG. 3 have common configurations, redundant descriptions thereof will be omitted.

As in the staple binder 155′ illustrated in FIG. 10, in the stapling process, the binding position is loosened and softened by applying liquid to the sheet P, and the staple can easily penetrate the sheet P. As a result, the number of sheets to be bound per sheet bundle Pb can be increased as compared with a case where the stapling process is performed without applying the liquid.

### Configuration of Second Liquid Storage Tank

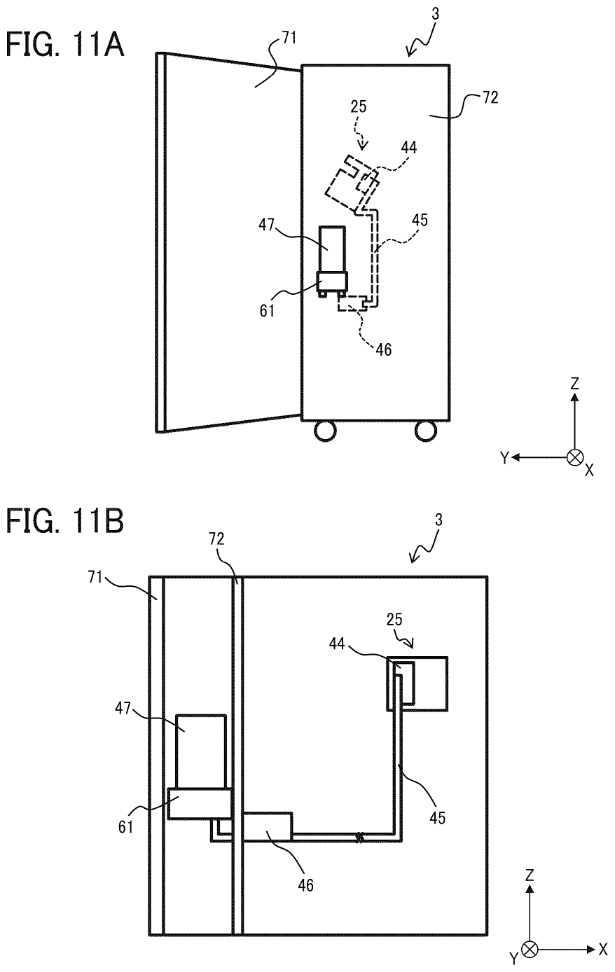

Referring now to FIGS. 11A, 11B, and 12A to 12C, a description is given of a location and configuration of the second liquid storage tank 47 in the post-processing apparatus 3.

FIGS. 11A and 11B are views illustrating the location and configuration of the second liquid storage tank 47 as the main tank in the post-processing apparatus 3.

FIG. 11A illustrates a state where a cover 71 constituting a part of an apparatus housing of the post-processing apparatus 3 is opened.

FIG. 11B is a cross-sectional side view of the post-processing apparatus 3, illustrating the post-processing apparatus 3 with the cover 71 closed.

As illustrated in FIG. 11A, the second liquid storage tank 47 is located so as to be accessible when the cover 71 of the post-processing apparatus 3 is opened. As illustrated in FIG. 11B, the second liquid storage tank 47 and the second liquid storage tank fixer 61 are disposed on the near side in a depth direction (X direction) of the post-processing apparatus 3. The first liquid storage tank 44, for example, are disposed on the far side in the depth direction (X direction) of the post-processing apparatus 3. A housing side plate 72 of the post-processing apparatus 3 is disposed between, for example, the location of the second liquid storage tank 47 and the second liquid storage tank fixer 61 and the location of the first liquid storage tank 44. The second liquid storage tank fixer 61 is attached to the housing side plate 72 of the post-processing apparatus 3.

FIGS. 12A to 12C are diagrams illustrating a configuration of attachment and detachment of the second liquid storage tank 47 in the post-processing apparatus 3.

FIGS. 12A to 12C illustrate a state in which the second liquid storage tank 47 is attachable to and detachable from the second liquid storage tank fixer 61 and a state in which liquid L is replenished to the second liquid storage tank 47.

As illustrated in FIG. 12A, the second liquid storage tank 47 is attachable to and detachable from the second liquid storage tank fixer 61 so as to replenish the first liquid storage tank 44 with liquid. As illustrated in FIG. 12B, the second liquid storage tank fixer 61 includes the setting detection sensor 51 that detects that the second liquid storage tank 47 is set on the second liquid storage tank fixer 61.

When the setting detection sensor 51 detects the set state of the second liquid storage tank 47 to the second liquid storage tank fixer 61 (see part FIG. 12C), a signal indicating the set state is transmitted to the controller 100b, which is described below. Thus, the controller 100b can determine whether the second liquid storage tank 47 is set on the second liquid storage tank fixer 61.

In addition, the second liquid storage tank fixer 61 is provided with a second liquid level sensor 94 as a second liquid detector for detecting the liquid level of the liquid L stored in the second liquid storage tank fixer 61 (referred to as “liquid L in the second liquid storage tank fixer 61”). The output value of the second liquid level sensor 94 is notified to the controller 100b, which will be described below. The controller 100b determines the output value of the second liquid level sensor 94 to determine whether the level of the liquid L in the second liquid storage tank fixer 61 is a necessary liquid level, in other words, whether the amount of liquid stored in the second liquid storage tank fixer 61 is a necessary liquid amount. When determining that the second liquid storage tank 47 is in the set state according to the output signal of the setting detection sensor 51, the controller 100b described below turns on the energization of the second liquid level sensor 94. Thus, the second liquid level sensor 94 can detect the level of the liquid L in the second liquid storage tank fixer 61, in other words, the presence or absence of the liquid L in the second liquid storage tank fixer 61.

When the second liquid storage tank 47 is not set on the second liquid storage tank fixer 61, a liquid discharge port 471a of the second liquid storage tank 47 is closed by a liquid supply valve 471 so that the liquid L does not leak. As illustrated in FIG. 12C, when the second liquid storage tank 47 is set on the second liquid storage tank fixer 61, the liquid supply valve 471 is pushed up to open the liquid discharge port 471a of the second liquid storage tank 47. As a result, the liquid L in the second liquid storage tank 47 flows out to the second liquid storage tank fixer 61. The liquid L that has flowed out from the second liquid storage tank 47 is stored in the second liquid storage tank fixer 61.

As a measure to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply passage 45 is conveyed by the liquid pump 46 to the second liquid storage tank fixer 61 via the liquid supply passage 45 in the reverse direction. For that purpose, the second liquid storage tank fixer 61 is set to the capacity that can sufficiently store the liquid L in the first liquid storage tank 44 and the liquid supply passage 45. As illustrated in FIGS. 12B and 12C, the second liquid storage tank fixer 61 is provided with a liquid drain plug 611. The liquid L remaining in the first liquid storage tank 44 and the liquid supply passage 45 is conveyed by the liquid pump 46 to the second liquid storage tank fixer 61 in the reverse direction. Thereafter, the liquid drain plug 611 is opened. By opening the liquid drain plug 611, the liquid L stored in the second liquid storage tank fixer 61 can be discharged to the outside of the post-processing apparatus 3.

### Configuration of Control Block of Post-Processing Apparatus

A description is given below of a control block of the post-processing apparatus 3, with reference to FIG. 13.

FIG. 13 is a hardware configuration diagram of a control block of the post-processing apparatus 3 according to the first embodiment.

As illustrated in FIG. 13, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3.

The RAM 102 is a volatile storage medium that allows high speed reading and writing of data, and is used as a working area when the CPU 101 processes information.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b serving as a controller or circuitry that controls the operation of the post-processing apparatus 3.

The I/F 105 is an interface that connects the conveyance roller pairs 10, 11, 14, and 15, the switcher 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid pump 46, the movement sensor 40a, the first liquid level sensor 43, the second liquid level sensor 94, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switcher 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid pump 46. The controller 100b acquires detection results from the movement sensor 40a, the first liquid level sensor 43, the second liquid level sensor 94, the setting detection sensor 51, the standby position sensor 540, and the encoder sensor 541. Although FIG. 13 illustrates only the components related to the edge binder 25 and the staple binder 155 that perform the edge binding process, the components related to the saddle binder 28 that performs the saddle binding are also controlled by the controller 100b.

As illustrated in FIG. 1, the image forming apparatus 2 includes the operation panel 110. The operation panel 110 includes an operation unit that receives instructions from a user and a display serving as a notifier that notifies the user of information. The operation unit includes, for example, physical input buttons and a touch panel overlaid on a display. The operation panel 110 acquires information from the user through the operation unit and provides the information to the user through the display. A specific example of the notifier is not limited to the display and may be a light-emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software, in other words, control programs executed by the CPU 101 with hardware resources included in the controller 100b.

The liquid application executed by the post-processing apparatus 3 may be performed by the staple binder 155 including the stapler 62 only, and the liquid application may be performed by using the liquid applier 31 included in the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration in which the stapler 62 and the second liquid applier 612 move along the guide shaft 49 as a single unit. However, the configuration of the staple binder is not limited to the above-described configuration. For example, the stapler 62 and the second liquid applier 612 may move separately.

### Description of Binding Process

A description is given below of the binding process executed by the edge binder 25 included in the post-processing apparatus 3.

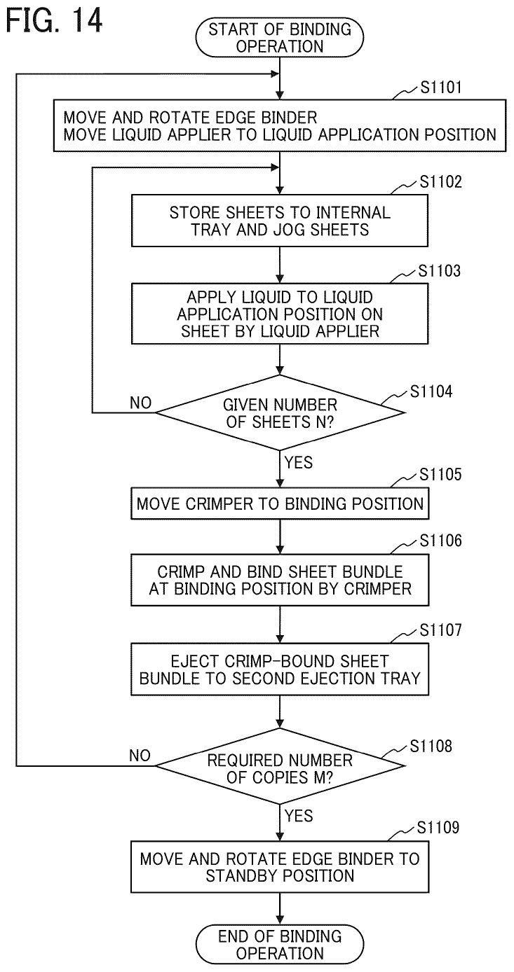

FIG. 14 is a flowchart of a one-point binding process executed by the edge binder 25.

FIGS. 15A, 15B, 15C, and 15D are diagrams illustrating the position shift of the edge binder 25 (including the liquid applier 31 and the crimper 32) during the one-point binding process.

Changes in the postures of the liquid applier 31 and the crimper 32 are omitted in FIGS. 15A to 15D. The position at which liquid application is executed (referred to as a “liquid application position”) on the sheet P or the sheet bundle Pb by the liquid applier 31 corresponds to the binding position on the sheet bundle Pb to be crimped and bound by the crimper 32. For this reason, in the following description, the liquid application position and the binding position are denoted by the same reference numeral (B1 and B2).

For example, the controller 100b starts the binding process illustrated in FIG. 14 when the controller 100b acquires an execution command of the binding process from the image forming apparatus 2. In the following description, the execution command of the binding process may be referred to as a “binding command”.

The binding command includes, for example, information related to the type of sheets P, the number of sheets P constituting the sheet bundle Pb, the number of copies of the sheet bundle Pb to be subjected to, for example, the binding process, the binding position of the sheet bundle Pb, and the binding posture of the edge binder 25. The information regarding the type of the sheet P includes information that affects the spread of the liquid, such as a material and a thickness. In the following description, the number of sheets P constituting the sheet bundle Pb is referred to as a “predetermined number N”. The number of copies of the sheet bundle Pb to be subjected to the binding process is referred to as a “necessary number of copies M”. The liquid applier 31 and the crimper 32 are assumed to be in a parallel binding posture and located at a standby position HP that is a position away in the main scanning direction from the sheets P placed on the internal tray 22 at the start of the binding process as illustrated in FIG. 15A.

When the posture that is instructed by the binding command is the “oblique binding posture”, the controller 100b drives the liquid applier pivot motor 563 and the crimper pivot motor 56 to rotate the liquid applier 31 and the crimper 32 of the edge binder 25 into the oblique binding posture (step S1101). When the posture is the “oblique binding posture”, the crimper 32 alone may be rotated to the oblique binding posture and the liquid applier 31 may be restricted not to rotate in the forward and reverse directions. Such a configuration can simplify the drive mechanism as compared with a configuration in which both the liquid applier 31 and the crimper 32 are rotated in the forward and reverse directions. Thus, the effects of cost reduction, the downsizing of the apparatus, and the reduction of a failure of devices are obtained.

On the other hand, when the posture that is instructed by the binding command is the “parallel binding posture”, the controller 100b omits the aforementioned operation of rotating the liquid applier 31 and the crimper 32 included in the edge binder 25 described above to the oblique binding posture. The controller 100b drives the edge binder movement motor 55 to move the edge binder 25 in the main scanning direction by the edge binder movement assembly 57 so that the liquid applier 31 faces the first liquid application position B1 instructed by the binding command (step S1101). The controller 100b executes the operation of step S1101 before a first sheet P is conveyed to the internal tray 22 by the conveyance roller pairs 10, 11, 14, and 15.

Then, the controller 100b rotates the conveyance roller pairs 10, 11, 14, and 15 to accommodate the sheet P on which an image has been formed by the image forming apparatus 2 on the internal tray 22 (step S1102). The controller 100b executes so-called jogging processing of aligning the positions in the main scanning direction of the sheet P or the sheet bundle Pb placed on the internal tray 22 by reciprocating the side fences 24L and 24R as aligners in the main scanning direction (step S1102).

The controller 100b causes the liquid applier 31 facing the first liquid application position B1 to apply liquid to the first liquid application position B1 of the sheet P placed on the internal tray 22 in the immediately preceding step S1102, based on liquid application control data adjusted in advance (step S1103). In other words, the controller 100b drives the liquid applier movement motor 42 to bring the liquid application member 501 into contact with the first liquid application position B1 on the sheet P placed on the internal tray 22 (see FIG. 15B). In the liquid application process in step S1703, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid applier movement motor 42 based on the adjusted control data, and adjusts the amount of movement of the liquid application member 501 with respect to the binding position B1 of the sheet P placed on the internal tray 22.

Then, the controller 100b determines whether the number of sheets P placed on the internal tray 22 has reached the given number of sheets N instructed by the binding command (step S1104). When the controller 100b determines that the number of sheets P placed on the internal tray 22 has not reached the given number of sheets N (No in step S1104), the controller 100b executes the operations of steps S1102 to S1104 again until the number of sheets P placed on the internal tray 22 reaches the given number of sheets N (Yes in step S1104).

In other words, the controller 100b executes the processing of steps S1102 to S1104 each time the sheet P is conveyed to the internal tray 22 by the conveyance roller pairs 10, 11, 14, and 15.

The liquid application by the liquid applier 31 may be performed not only on all of the multiple sheets P constituting the sheet bundle Pb, but also on only a part of the multiple sheets P.

When the controller 100b determines that the number of sheets P placed on the internal tray 22 has reached the given number of sheets N (Yes in step S1104), the controller 100b drives the edge binder movement motor 55 to move the edge binder 25 in the main scanning direction by the edge binder movement assembly 57 so that the crimper 32 faces the first binding position B1 as illustrated in FIG. 15C (step S1105).

The controller 100b causes the crimper 32 to crimp and bind the sheet bundle Pb placed on the internal tray 22 (step S1106). The controller 100b causes the conveyance roller pair 15 to eject the sheet bundle Pb thus crimped and bound by the crimper 32 to the second ejection tray 26 (step S1107). In other words, the controller 100b drives the contact-separation motor 32d to cause the upper crimping teeth 32a and the lower crimping teeth 32b to sandwich the sheet bundle Pb stacked on the internal tray 22 at the first binding position B1. In other words, the controller 100b drives the contact-separation motor 32d to cause the upper crimping teeth 32a and the lower crimping teeth 32b to sandwich the sheet bundle Pb stacked on the internal tray 22 at the first binding position B1. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is supported on the internal tray 22 has a crimping area (corresponding to the first binding position B1) sandwiched between the upper crimping teeth 32a and the lower crimping teeth 32b in step S1106. The crimping area overlaps with a liquid application area (corresponding to the first liquid application position B1) contacted by a distal end of the liquid application member 501 in step S1103. In other words, the crimper 32 crimps an area to which liquid is applied by the liquid applier 31 on the sheet bundle Pb placed on the internal tray 22. The crimping area sandwiched between the upper crimping teeth 32a and the lower crimping teeth 32b may completely or partially overlap with the liquid application area contacted by the distal end of the liquid application member 501, and can obtain a sufficient binding strength even in a case where the crimping area partially overlaps with the liquid application area.

The controller 100b determines whether the number of sheet bundles Pb thus ejected to the second ejection tray 26 has reached the requested number of copies M indicated by the binding command (step S1108). When the controller 100b determines that the number of sheet bundles Pb thus ejected has not reached the requested number of copies M (No in step S1108), the controller 100b executes the operations of step S1101 and subsequent steps again. In other words, when the controller 100b determines that the number of sheet bundles Pb thus ejected has not reached the requested number of copies M (Yes in step S1108), the controller 100b repeats the operations of steps S1101 to S1108 until the number of sheet bundles Pb ejected to the second ejection tray 26 reaches the requested number of copies M.

On the other hand, when the controller 100b determines that the number of sheet bundles Pb ejected to the second ejection tray 26 has reached the requested number of copies M (Yes in step S1108), the controller 100b drives the edge binder movement motor 55 to move the edge binder 25 including the liquid applier 31 and the crimper 32 to the standby position HP as illustrated in FIG. 15D (step S1109). When the posture that is instructed by the binding command is the “oblique binding posture”, the controller 100b drives the liquid applier pivot motor 563 and the crimper pivot motor 56 to rotate the liquid applier 31 and the crimper 32 into the parallel binding posture (step S1109). On the other hand, when the posture that is instructed by the binding command is the “parallel binding posture”, the controller 100b skips the aforementioned operation of rotating the liquid applier 31 and the crimper 32 to the parallel binding posture.

As a result, the edge binder 25 (including the liquid applier 31 and the crimper 32) returns to the standby position HP as illustrated in FIG. 15D. In steps S1101 and S1109, the order of execution of the operation of moving the edge binder 25 in the main scanning direction by the edge binder movement assembly 57 and the operation of rotating the liquid applier 31 and the crimper 32 in the forward and reverse directions by the liquid applier pivot motor 563 and the crimper pivot motor 56 is not limited to the above-described order, and may be the order opposite to the above-described order.

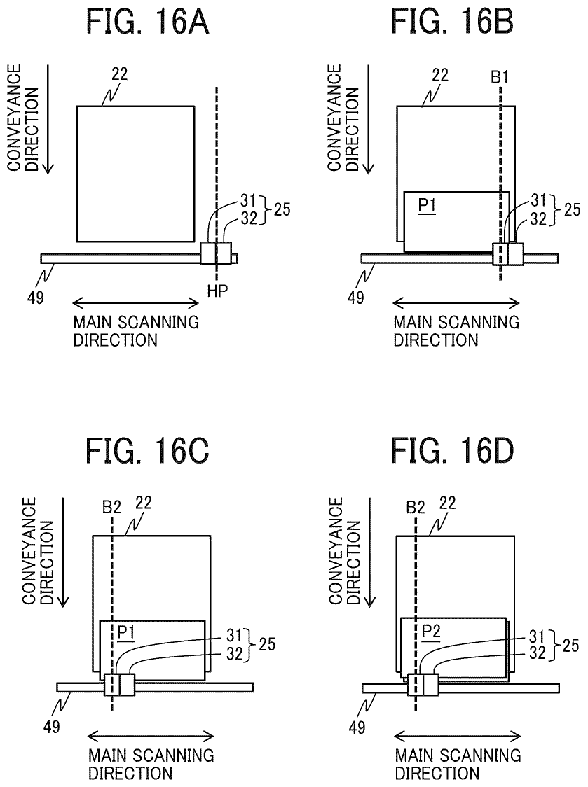

FIGS. 16A, 16B, 16C, 16D, 16E, 16F, 16G, and 16H are diagrams illustrating the position shift of the edge binder 25 during execution of two-point binding process.

A detailed description of points common to the process described with reference to FIGS. 15A to 15D may be omitted, and differences will be mainly described.

As illustrated in FIG. 16A, it is assumed that the edge binder 25 is located at the standby position HP at the start point of the two-point binding process. The first binding position B1 and the second binding position B2 are apart from each other in the main scanning direction. In FIGS. 16A to 16H, a case where two sheets P1 and P2 are crimped and bound, in other words, a case where N=2 will be described. In the case of executing the two-point binding process, the number of sheets P included in the sheet bundle Pb is not limited to two, and the two-point binding can be performed on a sheet bundle Pb having the same number of sheets as the number of sheets that can be bound in one-point binding process.

Before a first sheet P1 for a sheet bundle Pb is supplied to the internal tray 22, the controller 100b causes the edge binder 25 to move in the main scanning direction by the edge binder movement assembly 57 such that the liquid applier 31 can face the first liquid application position B1 (see FIG. 16B). Subsequently, as illustrated in FIG. 16B, the controller 100b places the liquid applier 31 at the position to face the first liquid application position B1. With this state, the sheet P1 on which an image has been formed by the image forming apparatus 2 is placed on the internal tray 22, and the controller 100b executes jogging processing by reciprocating the side fences 24L and 24R in the main scanning direction. In response to the placement of the first sheet P1 on the internal tray 22, the controller 100b causes the liquid applier 31 to apply the liquid to the first liquid application position B1 of the first sheet P1.

Subsequently, as illustrated in FIG. 16C, the controller 100b causes the edge binder 25 to move in the main scanning direction by the edge binder movement assembly 57 such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid to the first liquid application position B1 and the second liquid application position B2 of the first sheet P1, the controller 100b causes a second sheet P2 for the sheet bundle Pb to be placed on the internal tray 22 and executes the jogging processing by the side fences 24L and 24R in a state where the liquid applier 31 is disposed at a position which the liquid applier 31 can face the second liquid application position B2 as illustrated in FIG. 16D. In response to the placement of the second sheet P2 on the internal tray 22, the controller 100b causes the liquid applier 31 to apply the liquid to the second liquid application position B2 of the second sheet P2.

Subsequently, as illustrated in FIG. 16E, the controller 100b causes the edge binder 25 to move in the main scanning direction by the edge binder movement assembly 57 such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeatedly execute the conveyance of the sheet P and the liquid application to the first liquid application position B1 and the second liquid application position B2 until the number of sheets P placed on the internal tray 22 reaches the given number of sheets N. At this time, the controller 100b causes the liquid applier 31 to perform the liquid application to the B-th sheet P (B<N) in the order of the first liquid application position B1 and the second liquid application position B2. The controller 100b also causes the liquid applier 31 to perform the liquid application to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, when the controller 100b determines that the number of sheets P placed on the internal tray 22 has reached the given number of sheets N, the controller 100b causes the edge binder 25 to move in the main scanning direction by the edge binder movement assembly 57 so that the crimper 32 faces the first binding position B1 as illustrated in FIG. 16F. The controller 100b causes the crimper 32 to crimp and bind the first binding position B1 of the sheet bundle Pb including the first sheet P1 and the second sheet P2 placed on the internal tray 22. Then, as illustrated in FIG. 16G, the controller 100b causes the edge binder 25 to move in the main scanning direction by the edge binder movement assembly 57 such that the crimper 32 faces the second binding position B2 of the sheet bundle Pb. The controller 100b causes the crimper 32 to crimp and bind the second binding position B2 of the sheet bundle Pb placed on the internal tray 22.

In the example illustrated in FIGS. 16A to 16H, since the controller 100b causes the liquid applier 31 to finally apply the liquid to the first liquid application position B1, the crimper 32 performs the crimp binding processes in the order of the first binding position B1 and the second binding position B2. On the other hand, in a case where the controller 100b causes the liquid applier 31 to execute the liquid application to the second liquid application position B2 last, the controller 100b may cause the crimper 32 to execute the crimping in the order of the second binding position B2 and the first binding position B1.

In other words, as illustrated in FIGS. 16A to 16H, the controller 100b can cause the edge binder movement assembly 57 to move the edge binder 25 by the shortest distance between the position at which the liquid applier 31 faces the first liquid application position B1 and the position at which the liquid applier 31 faces the second liquid application position B2 without passing through the standby position HP. The edge binder movement assembly 57 can also move the edge binder 25 by the shortest distance between the position at which the crimper 32 faces the first binding position B1 and the position at which the crimper 32 faces the second binding position B2 without passing through the standby position HP. Further, the edge binder movement assembly 57 can move the edge binder 25 by the shortest distance between the position where the liquid applier 31 faces the first liquid application position B1 (alternatively, the second liquid application position B2) and the position where the crimper 32 faces the first binding position B1 (alternatively, the second binding position B2) without passing through the standby position HP. Accordingly, productivity of the crimp binding can be enhanced.

Then, the controller 100b causes the conveyance roller pair 15 to rotate to eject the sheet bundle Pb to the second ejection tray 26 after the sheet bundle Pb is crimped and bound by the crimper 32 at the first binding position B1 and the second binding position B2. Further, as illustrated in FIG. 16H, the controller 100b drives the edge binder movement motor 55 to move the edge binder 25 including the liquid applier 31 and the crimper 32 to the standby position HP.

Although an example in which one or two positions of the sheet bundle Pb are crimped and bound has been described in the above-described embodiment, an embodiment of the present disclosure is also applicable to a case in which three or more positions of the sheet bundle Pb spaced apart from each other in the main scanning direction are crimped and bound. In such cases, the controller 100b causes the liquid applier 31 to apply the liquid to three or more liquid application positions (corresponding to the crimp binding positions) and causes the crimper 32 to perform crimping. Even in the case of crimping three or more locations, the productivity of the crimp binding can be enhanced by applying the present disclosure.

However, it is not necessary to apply the liquid to all the liquid application positions (corresponding to crimp binding positions) for all the sheets P included in the sheet bundle Pb. For example, when crimp binding is performed on three crimp binding positions apart from each other in the main scanning direction, the controller 100b may cause the liquid applier 31 to apply the liquid to three liquid application positions (corresponding to crimp binding positions) of an E-th sheet P1 (E<N−2), apply the liquid to two liquid application positions (corresponding to crimp binding positions) of an (E+1)-th sheet P2, and apply the liquid to one liquid application position (corresponding to a crimp binding position) of an (E+2)-th sheet P2.

### Embodiment of Sheet Removing Mechanism

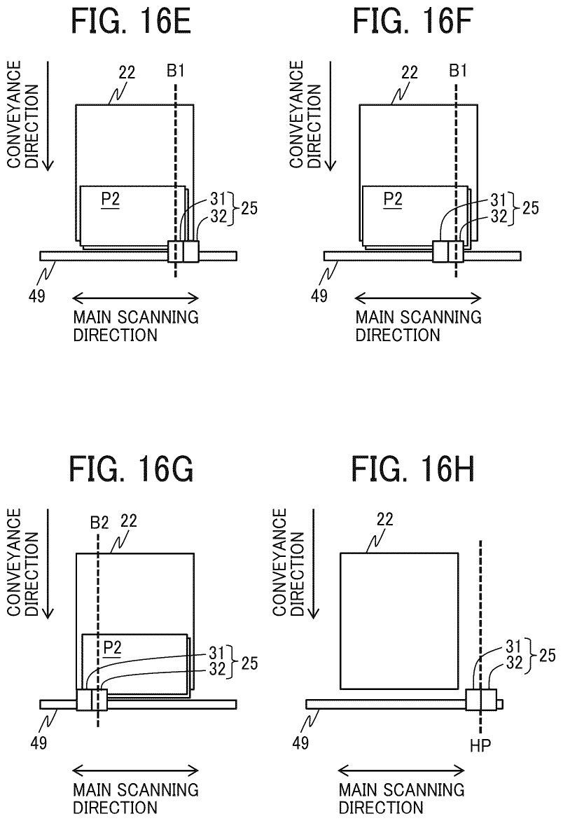

A more detailed description is given of the sheet removing mechanism 320 included in the crimper 32 according to the present embodiment. As illustrated in FIG. 17, the crimper 32 is configured such that the crimping frame 32c includes upper crimping teeth 32a and lower crimping teeth 32b as crimping teeth, and the upper crimping teeth 32a move toward the lower crimping teeth 32b by driving of the contact-separation motor 32d (see FIG. 13). By this moving operation, the sheet bundle Pb placed between the upper crimping teeth 32a and the lower crimping teeth 32b is pressed, and crimp binding with respect to a predetermined position, in other words, a binding position is executed.

In the crimp binding, of the sheets P constituting the sheet bundle Pb, the sheet P at a position in contact with the upper crimping teeth 32a and the lower crimping teeth 32b sometimes adheres to the upper crimping teeth 32a and the lower crimping teeth 32b. The sheet P adhered to the upper crimping teeth 32a is easily removed off by a raising operation of the upper crimping teeth 32a. However, since the lower crimping teeth 32b do not move relative to the sheet bundle Pb in the crimp binding operation, the sheet P adhered to the lower crimping teeth 32b may not be easily removed off only by the crimp binding operation. When the operation of ejecting the sheet bundle Pb is executed in a state where a part of the sheet bundle Pb is stuck to the lower crimping teeth 32b, the sheet P is caught by the lower crimping teeth 32b to be torn, or the alignment of the sheet bundle Pb is disturbed.

Therefore, the crimper 32 integrally includes a sheet removing mechanism 320 that can remove the sheet P adhered to the lower crimping teeth 32b among the sheets P constituting the sheet bundle Pb in the crimp binding operation. Even if the sheet P adheres to the lower crimping teeth 32b in the crimp binding operation, the sheet removing mechanism 320 can perform an operation of separating the sheet P from the lower crimping teeth 32b along with the operation of raising the upper crimping teeth 32a. Even when the sheet P adheres to the lower crimping teeth 32b constituting the crimper 32 by the sheet removing mechanism 320, the sheet P can be reliably removed from the lower crimping teeth 32b constituting the crimper 32 until the operation of ejecting the sheet bundle Pb is started. In other words, in the case of the crimper 32 according to the present embodiment, adhesion of the sheet P constituting the sheet bundle Pb to the lower crimping teeth 32b, which is likely to occur when the crimp binding involving liquid application is performed, can be prevented. Alignment failure of the sheets P and damage to the sheets P can be suppressed, and the binding quality of the sheet bundle Pb by the crimp binding operation can be enhanced. As will be described below, even when the sheet P constituting the sheet bundle Pb adheres to the sheet removing mechanism 320, an operation of removing the sheet P can be performed.

In particular, when liquid is applied to the sheet P, the sheet P is more likely to adhere to the lower crimping teeth 32b constituting the crimper 32. Even in this case, the sheet P constituting the sheet bundle Pb can be reliably removed from the lower crimping teeth 32b constituting the crimper 32.

As illustrated in FIG. 17, the sheet removing mechanism 320 according to the present embodiment includes at least a remover 321, a removing cam 322, and an elastic member 323.

The remover 321 is rotatably held with respect to the crimping frame 32c at remover joint portions 3211a and 3211b.

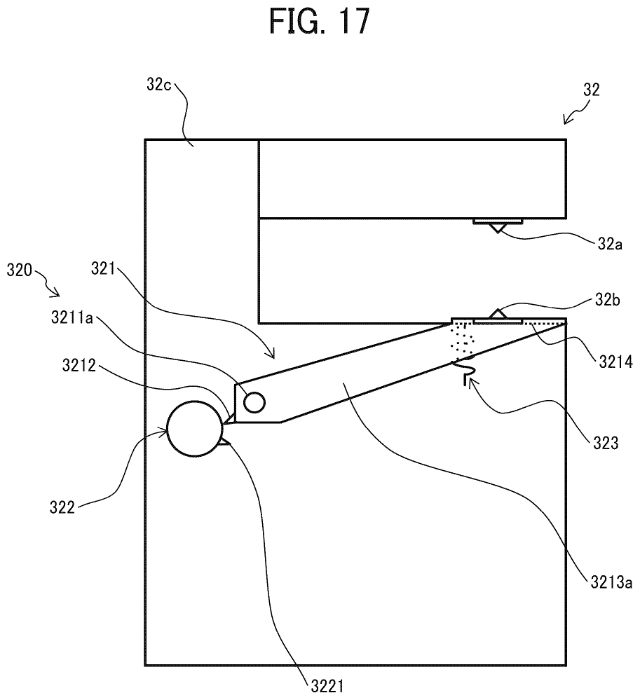

FIG. 18 is a diagram illustrating an example of the remover 321 integrally provided in the crimper 32. In other words, FIG. 18 is a perspective view of the remover 321.

As illustrated in FIG. 18, the remover 321 is configured to have a U-shape by connecting ends of two removing support portions 3213a and 3213b provided with a remover joint portion 3211a and a remover joint portion 3211b by a removing beam portion 3214. The remover 321 includes the removing beam portion 3214 as a contact portion that comes in contact with a part of the sheet bundle Pb when the pressure to the sheet bundle Pb by the crimper 32 is performed. The removing beam portion 3214 includes a removing hole portion 3215 in a portion overlapping with the lower crimping teeth 32b.

The removing hole portion 3215 is formed such that the lower crimping teeth 32b penetrates through the removing hole portion 3215 and protrudes from the removing hole portion 3215 beyond the thickness of the removing beam portion 3214 toward the upper crimping teeth 32a in a first removing operation (described below for details). In other words, when the upper crimping teeth 32a descends and the sheet bundle Pb is sandwiched between the lower crimping teeth 32b and the upper crimping teeth 32a, the lower crimping teeth 32b can be fitted to the upper crimping teeth 32a. At least one of the removing support portion 3213a or the removing support portion 3213b is provided with a removing projection 3212 at a position corresponding to the outer peripheral portion of the removing support portion 3213a, the removing support portion 3213b or both in the vicinity of the remover joint portion 3211a, the remover joint portion 3211b, or both.

As illustrated in FIG. 17, the removing cam 322 is disposed at a position facing the removing projection 3212 provided in the removing support portion 3213a. In addition, the removing cam 322 supplies a driving force for rotating the remover 321 with the remover joint portion 3211a as a fulcrum and the removing beam portion 3214 as an action point. The removing cam 322 has a cam projection 3221 on the side facing the removing support portion 3213a. As described below, when the removing cam 322 rotates, the cam projection 3221 rotates while contacting the removing projection 3212 provided on the removing support portion 3213a. As a result, the driving force of the removing cam 322 is transmitted to the removing support portion 3213a and the removing support portion 3213b via the cam projection 3221 and the removing projection 3212. As a result, the removing support portion 3213a and the removing support portion 3213b of the remover 321 are configured to rotate with the remover joint portion 3211a and the remover joint portion 3211b as fulcrums.

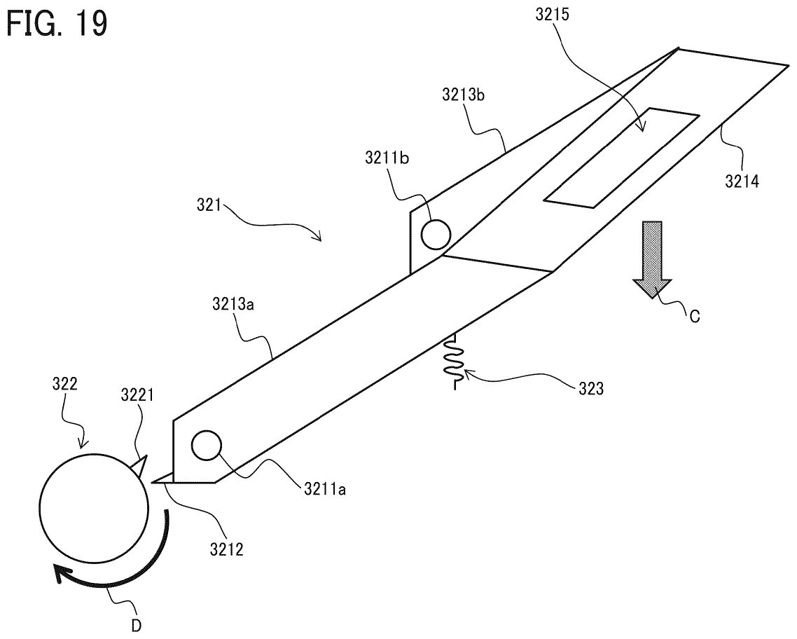

The elastic member 323 applies a biasing force (see an arrow C in FIG. 20) for biasing the removing beam portion 3214 toward the lower crimping teeth 32b to the remover 321 so as to maintain a state in which the lower crimping teeth 32b protrudes from the removing hole portion 3215.

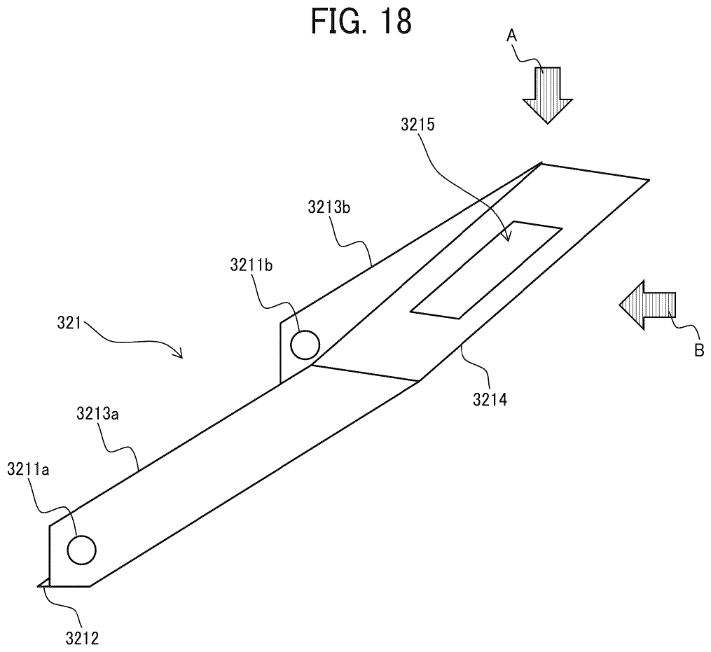

FIGS. 19 and 20 are views for describing the state of the operation of the remover 321 when the operation of crimp binding is executed.

First, the remover 321 is biased in the direction of arrow C by the elastic member 323. When the contact-separation motor 32d is driven to move the upper crimping teeth 32a, the removing cam 322 is configured to rotate in the direction of the arc arrow D. In order for the upper crimping teeth 32a to sandwich the sheet bundle Pb between the lower crimping teeth 32b and to press and deform the sheet bundle Pb, the contact-separation motor 32d is driven so that the upper crimping teeth 32a move toward the lower crimping teeth 32b. Then, after the pressure change of the sheet bundle Pb by the upper crimping teeth 32a and the lower crimping teeth 32b, the removing cam 322 rotates in the direction of the arc arrow D by the driving of the contact-separation motor 32d for raising the upper crimping teeth 32a. When the removing cam 322 rotates in the direction of the arc arrow D, the cam projection 3221 provided on the removing cam 322 comes into contact with and pushes the removing projection 3212 provided on the removing support portion 3213a. At this time, the removing projection 3212 provided on the removing support portion 3213a is pushed in the direction of the arc arrow D.

As illustrated in FIG. 20, when the contact-separation motor 32d is driven to raise the upper crimping teeth 32a, the cam projection 3221 provided on the removing cam 322 pushes the removing projection 3212 provided on the removing support portion 3213a in the direction of the arc arrow D. As a result, the removing support portion 3213a rotates in the direction opposite to the arc arrow D, in other words, in the arc arrow D′ direction with the remover joint portion 3211a as a fulcrum. In other words, by the driving force of the removing cam 322 transmitted from the cam projection 3221 to the removing projection 3212, the removing support portions 3213a and 3213b rotate about the remover joint portions 3211a and 3211b in the direction of the arc arrow D′. As a result, the removing beam portion 3214 provided across the end portions of the removing support portions 3213a and 3213b is flipped up in the direction of the arrow E against the biasing in the direction of the arrow C by the elastic member 323.

In other words, in the operation of raising the upper crimping teeth 32a, the remover 321 is configured to rotate in the direction of the arrow E, which is a direction against the biasing force of the elastic member 323 (the direction of the arrow C in FIG. 20), with the remover joint portions 3211a and 3211b as fulcrums. By this rotation, the removing beam portion 3214 moves in a direction away from the lower crimping teeth 32b. As a result, even if the sheet P constituting the sheet bundle Pb adheres to the lower crimping teeth 32b constituting the lower crimping teeth 32b, the sheet P is peeled off from the lower crimping teeth 32b by the removing beam portion 3214.

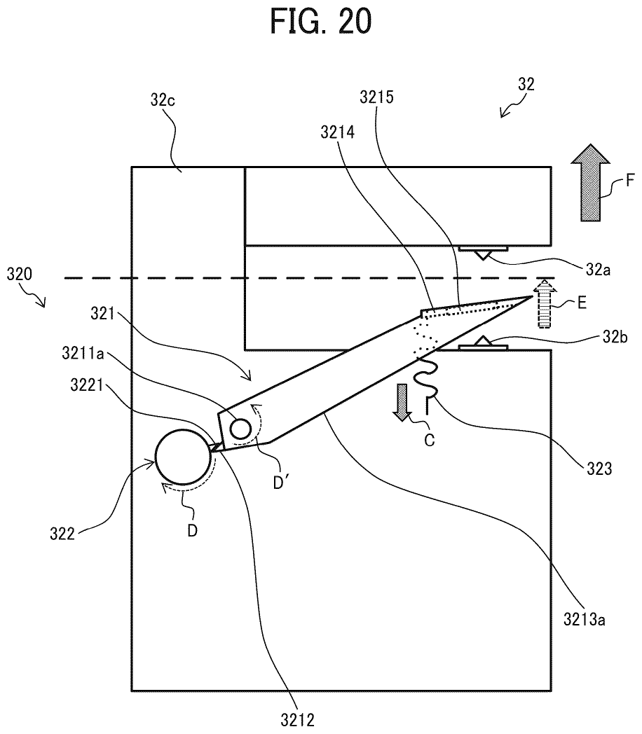

FIG. 21 is a perspective view of a state of the sheet removing mechanism 320 in FIG. 20.

As illustrated in FIG. 21, the remover 321 rotates in a direction against the biasing force of the elastic member 323 with the remover joint portions 3211a and 3211b as a fulcrum, so that the removing beam portion 3214 moves in a direction away from the lower crimping teeth 32b. As a result, even if the sheet P constituting the sheet bundle Pb adheres to the lower crimping teeth 32b, the sheet P is peeled off from the lower crimping teeth 32b by the removing beam portion 3214.

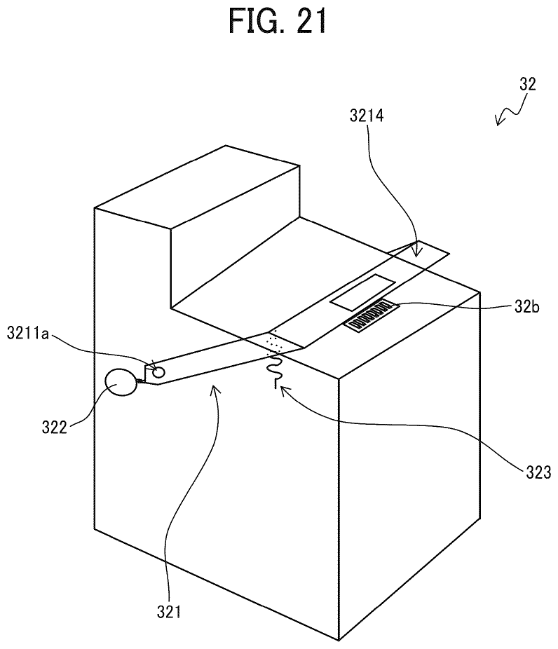

FIG. 22 illustrates a positional relationship between the remover 321 constituting the sheet removing mechanism 320 and the lower crimping teeth 32b.

FIG. 22 is a plan view of the removing beam portion 3214 of the remover 321 when viewed from the direction of the arrow A in FIG. 18.

As illustrated in FIG. 22, the removing hole portion 3215 provided in the removing beam portion 3214 of the remover 321 is formed to have a dimension slightly larger than the outer peripheral dimension of the lower crimping teeth 32b. As a result, even if the removing beam portion 3214 of the remover 321 is biased toward the lower crimping teeth 32b by the removing elastic member 323, the tooth portion of the lower crimping teeth 32b protrudes from the remover 321 toward the upper crimping teeth 32a (see FIG. 17). Thus, the lower crimping teeth 32b can sandwich the sheet bundle Pb with the upper crimping teeth 32a.

### Embodiment of Binding Process Flow According to the Present Disclosure

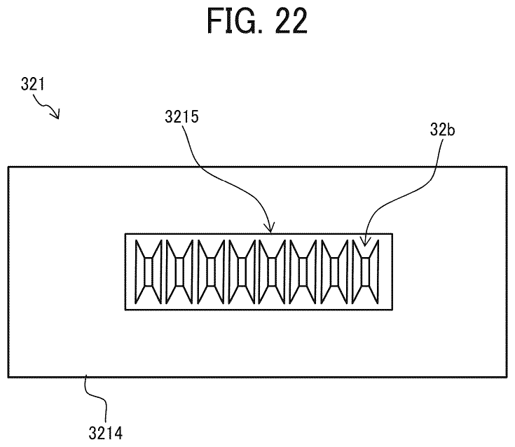

A description is given of the flow of the crimp binding process by the crimper 32 including the sheet removing mechanism 320 with reference to a flowchart of FIG. 23. The flowchart illustrated in FIG. 23 includes processing common to the flowchart of the binding process already described with reference to FIG. 14. The description of the processing steps already described will be simplified, and specific processing steps in the binding process executed using the crimper 32 according to the present embodiment will be described in detail.

As described above, according to the orientation instructed by the binding command, the controller 100b brings the crimper 32 and the liquid applier 31 into the predetermined binding orientation, and moves the edge binder 25 in the main scanning direction such that the liquid applier 31 faces the first liquid application position B1 instructed by the binding command (step S2001).

Subsequently, the controller 100b rotates the conveyance roller pairs 10, 11, 14, and 15 to store the sheet P on which the image is formed by the image forming apparatus 2 in the internal tray 22, and executes jogging processing of reciprocating the side fences 24 L and 24R in the main scanning direction (step S2002).

Subsequently, the controller 100b causes the liquid applier 31 to execute liquid application to the first liquid application position B1 of the sheet P placed on the internal tray 22 in step S2002 (step S2003).

Then, the controller 100b determines whether the number of sheets P placed on the internal tray 22 has reached the given number of sheets N instructed by the binding command (step S2004). When the controller 100b determines that the number of sheets P placed on the internal tray 22 has not reached the given number of sheets N (No in step S2004), the controller 100b executes the operations of steps S2002 to S2004 again until the number of sheets P placed on the internal tray 22 reaches the given number of sheets N (Yes in step S2004).

Subsequently, when the controller 100b determines that the number of sheets P placed on the internal tray 22 has reached the given number of sheets N (Yes in step S2004), the controller 100b causes the edge binder 25 to move in the main scanning direction such that the crimper 32 faces the first binding position B1 (step S2005).

The controller 100b causes the crimper 32 to crimp and bind the sheet bundle Pb placed on the internal tray 22 (step S2006). After the sheet bundle Pb is sandwiched by the upper crimping teeth 32a and the lower crimping teeth 32b in step S2006, as illustrated in FIG. 20, the upper crimping teeth 32a are separated from the lower crimping teeth 32b in the arrow F direction. The remover 321 is thereby lifted up, and a “first removing operation” of removing the sheet P constituting the sheet bundle Pb from the lower crimping teeth 32b is executed (step S2007).

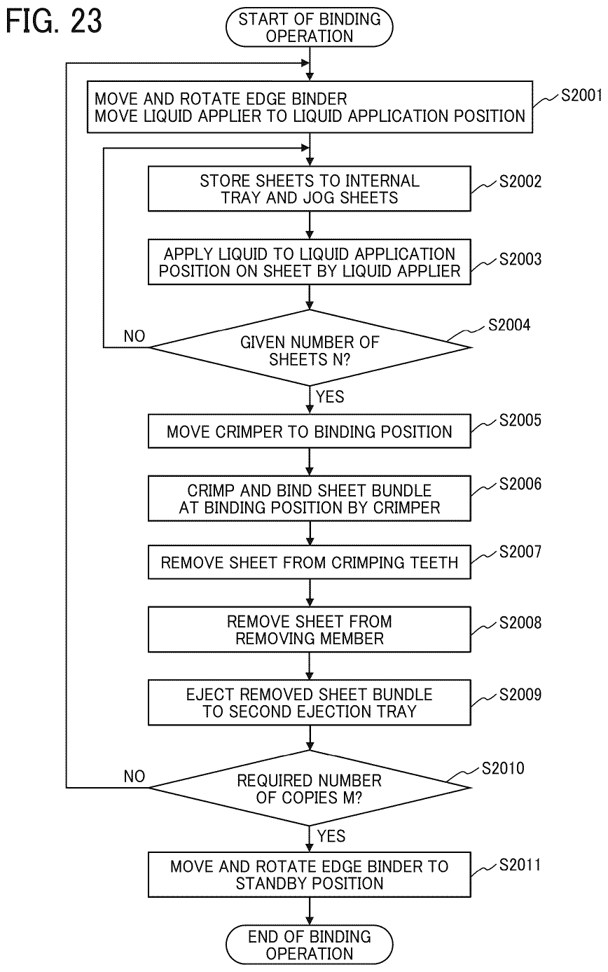

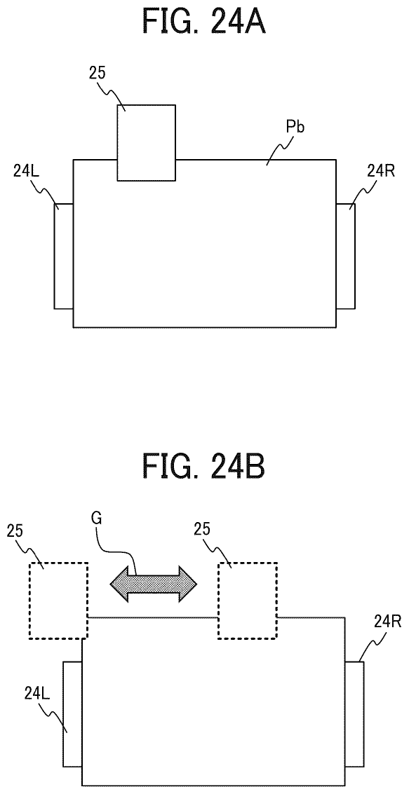

Subsequently, as illustrated in FIGS. 24A and 24B, the controller 100b drives the edge binder movement motor 55 to execute a “second removing operation” of moving the edge binder 25 including the crimper 32 in the main scanning direction (the arrow G direction in FIG. 24B) in order to peel the sheet P constituting the sheet bundle Pb attached to the removing beam portion 3214 of the remover 321 from the removing beam portion 3214 (step S2008). In step S2008, as illustrated in FIGS. 25A and 25B, the controller 100b may execute the “second removing operation” by moving the side fences 24L and 24R in the arrow H direction of FIG. 25B to relatively move the sheet bundle Pb placed on the internal tray 22 in the main scanning direction with respect to the removing beam portion 3214 of the remover 321 (FIGS. 25A and 25B).

The controller 100b causes the conveyance roller pair 15 to eject the sheet bundle Pb thus crimped and bound by the crimper 32 to the second ejection tray 26 (step S2009).

The controller 100b determines whether the number of sheet bundles Pb thus ejected to the second ejection tray 26 has reached the requested number of copies M indicated by the binding command (step S2010). When the controller 100b determines that the number of sheet bundles Pb thus ejected has not reached the requested number of copies M (No in step S2010), the controller 100b executes the operations of step S2001 and the following steps again. In other words, until the number of sheet bundles Pb ejected to the second ejection tray 26 reaches the requested number of copies M (Yes in step S2010), the controller 100b repeats the operations of steps S2001 to S2010.

On the other hand, when determining that the number of copies of the sheet bundle Pb ejected to the second ejection tray 26 has reached the required number of copies M (Yes in S2010), the controller 100b drives the edge binder movement motor 55 to move the edge binder 25 including the liquid applier 31 and the crimper 32 to the standby position HP and return the posture to the original posture (step S2011).

FIGS. 24A and 24B illustrate a first example of a “second removing operation” of a method of shifting the relative positional relationship between the sheet P and the edge binder 25 in the main scanning direction in step S2008.

First, FIG. 24A illustrates a relative positional relationship between the edge binder 25 and the sheet bundle Pb when the crimp binding process is performed by the crimper 32.

FIG. 24B illustrates an operation of driving the edge binder movement motor 55 to move the edge binder 25 in the main scanning direction (the arrow G direction in FIG. 24B), thereby releasing the bonding between the removing beam portion 3214 of the remover 321 included in the crimper 32 and the sheets P constituting the sheet bundle Pb.

The moving direction of the edge binder 25 may be the main scanning direction, and may be the movement along the end of the sheet bundle Pb.

FIGS. 25A and 25B illustrate a second example of the “second removing operation” of a method of shifting the relative positional relationship between the sheet P and the edge binder 25 in the main scanning direction in step S2008.

First, FIG. 25A illustrates a relative positional relationship between the edge binder 25 and the sheet bundle Pb when the crimp binding process is performed by the crimper 32.

FIG. 25B illustrates an operation of moving the sheet bundle Pb in the main scanning direction (the arrow H direction in FIG. 25B) by the operations of the side fences 24L and 24R to release the adhesion between the crimper 32 included in the edge binder 25 and the sheets P constituting the sheet bundle Pb.

As illustrated in FIGS. 25A and 25B, the positional relationship between the crimper 32 included in the edge binder 25 and the sheet bundle Pb is relatively shifted in a state where the end in the width direction of the sheet bundle Pb is held by the side fences 24L and 24R. The shifting direction at this time is the main scanning direction. As a result, by removing the sheet P constituting the sheet bundle Pb from the lower crimping teeth 32b included in the crimper 32, the adhesion of the sheet P constituting the sheet bundle Pb adhered to the sheet removing mechanism 320 can be released.

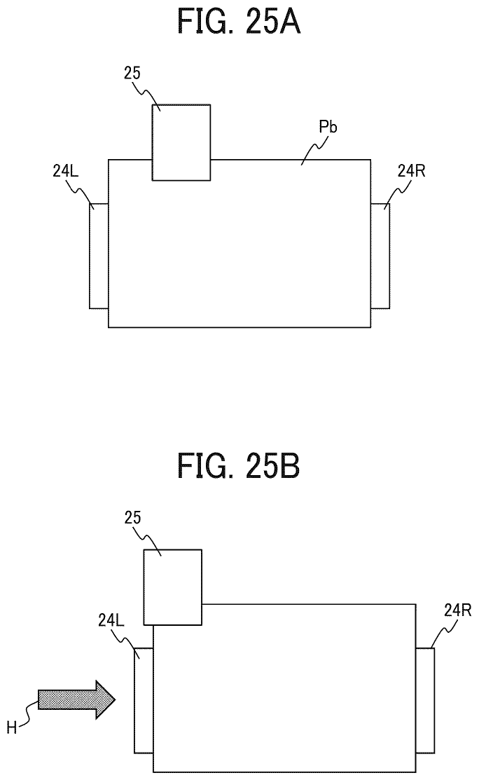

FIG. 26 is a view illustrating Modification 1 which is another configuration example of the remover 321.

FIG. 26 is a view of a remover 321b according to Modification 1 as viewed from a direction of an arrow A in FIG. 18.

As illustrated in FIG. 26, in the remover 321a, a slit 3216 is provided in a part of the removing beam portion 3214a as the contact portion. The slits 3216 are formed, for example, at both ends in the main scanning direction on a surface where the removing beam portion 3214a comes in contact with the sheets P constituting the sheet bundle Pb. The removing beam portion 3214a includes a removing hole portion 3215a in a portion overlapping with the lower crimping teeth 32b.

The slit 3216 can reduce the area in which the sheets P constituting the sheet bundle Pb adheres to the removing beam portion 3214a of the remover 321a, in other words, the contact area. As a result, when the operation of shifting the relative positional relationship between the sheet P constituting the sheet bundle Pb and the crimper 32 included in the edge binder 25 in the main scanning direction is performed in the “second removing operation” in step S2008, the sheet P constituting the sheet bundle Pb attached to the removing beam portion 3214a of the remover 321a is easily peeled off from the removing beam portion 3214a.

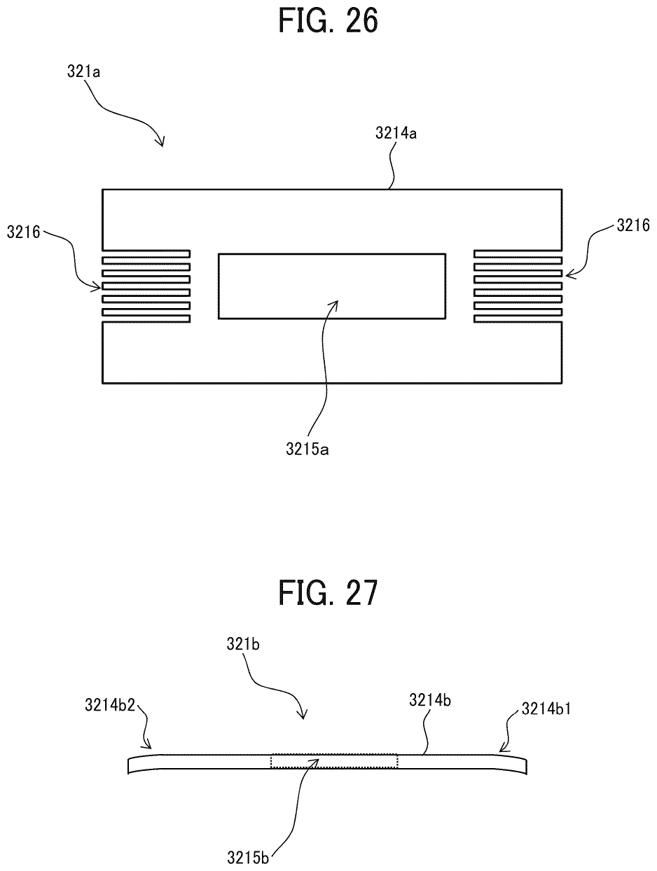

FIG. 27 is a view illustrating Modification 2 which is still another configuration example of the remover 321.

FIG. 27 is a view of a remover 321b according to Modification 2 as viewed from a direction of an arrow B in FIG. 18.

As illustrated in FIG. 27, the remover 321b has a removing beam portion 3214b as a contact portion. The removing beam portion 3214b includes curved portions 3214b1 and 3214b2 in which the surfaces come in contact with the sheets P constituting the sheet bundle Pb are not entirely flat in the main scanning direction, but are slightly curved near both ends in the main scanning direction. The removing beam portion 3214b includes a removing hole portion 3215b in a portion overlapping with the lower crimping teeth 32b.

By the curved portions 3214b1 and 3214b2, the area in which the sheet P constituting the sheet bundle Pb adheres to the remover 321a, in other words, the contact area can be reduced. As a result, when the operation of shifting the relative positional relationship between the sheet P constituting the sheet bundle Pb and the crimper 32 included in the edge binder 25 in the main scanning direction is performed in the “second removing operation” in step S2008, the sheet P constituting the sheet bundle Pb attached to the removing beam portion 3214b of the remover 321b is easily peeled off.

### Another Embodiment of Binding Process Flow According to the Present Disclosure

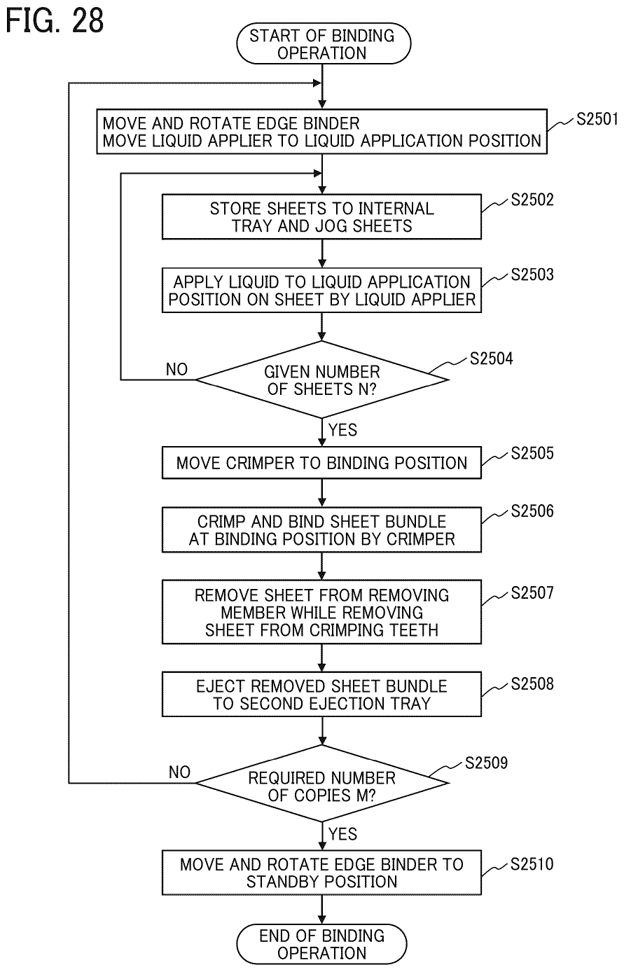

Another embodiment of the flow of the crimp binding process by the crimper 32 including the sheet removing mechanism 320 will be described with reference to the flowchart of FIG. 28. The processing in steps S2001 to S2006 and S2009 to S2011 described in FIG. 23 and the processing in steps S2501 to S2506 and S2508 to S2510 illustrated in FIG. 28 are similar to each other, and thus detailed description thereof is omitted.

In the flowchart illustrated in FIG. 28, the process of combining step S2007 and step S2008 of the flowchart of FIG. 23 is executed as step S2507 of FIG. 28. In other words, the operation is performed such that the “first removing operation” and the “second removing operation” are simultaneously executed in the crimp binding operation. More particularly, in conjunction with the opening operation of the crimp binding operation, in other words, the operation of separating the upper crimping teeth 32a and the lower crimping teeth 32b, the “first removing operation” that is the operation of removing the sheet P constituting the sheet bundle Pb from the lower crimping teeth 32b by lifting up the remover 321 and the “second removing operation” that is the operation of shifting the positions of the sheet P constituting the sheet bundle Pb and the edge binder 25 in the main scanning direction in order to peel the sheet P constituting the sheet bundle Pb adhered to the remover 321 from the remover 321 are simultaneously performed (step S2507).

During the “first removing operation”, a force for moving the sheets P constituting the sheet bundle Pb in the vertical direction (a force in the arrow E direction in FIG. 20) is applied. In the “second removing operation”, a force (force in arrow G direction in FIG. 24B or force in arrow F direction in FIG. 25B) for moving the sheets P constituting the sheet bundle Pb in the left-right direction is applied. Therefore, by executing the “first removing operation” and the “second removing operation” at the same timing, a force for moving the sheets P constituting the sheet bundle Pb up, down, left, and right can be simultaneously applied to the sheets P constituting the sheet bundle Pb. As a result, the time for removing the sheet P constituting the sheet bundle Pb attached to the lower crimping teeth 32b and the remover 321 can be reduced from the lower crimping teeth 32b and the remover 321, and the efficiency of the removing operation can be enhanced. In addition, the productivity of the binding process can be enhanced by enhancing the efficiency of the removing operation.

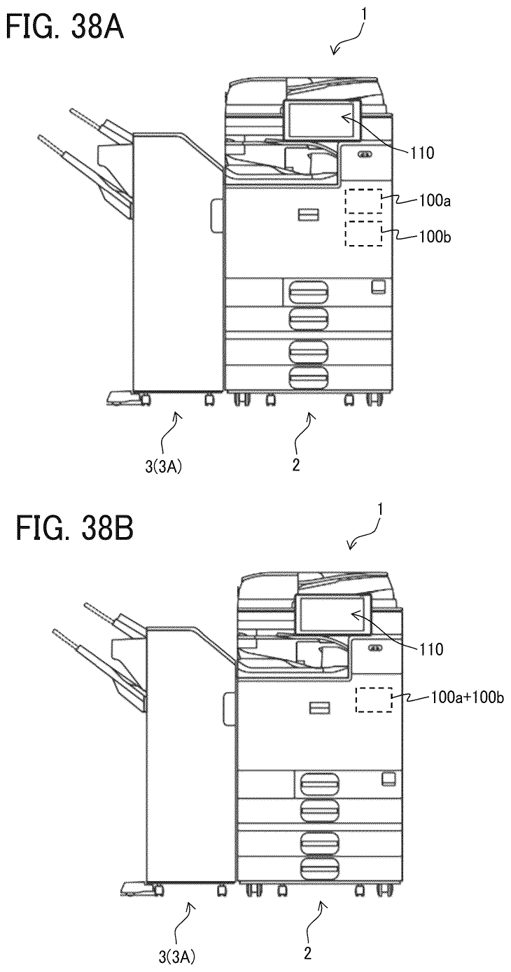

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 38A, the controller 100b of the post-processing apparatus 3 may be disposed in the image forming apparatus 2. Further, as illustrated in FIG. 38B, the controller 100b of the post-processing apparatus 3 may be integrated with the controller 100a of the image forming apparatus 2.

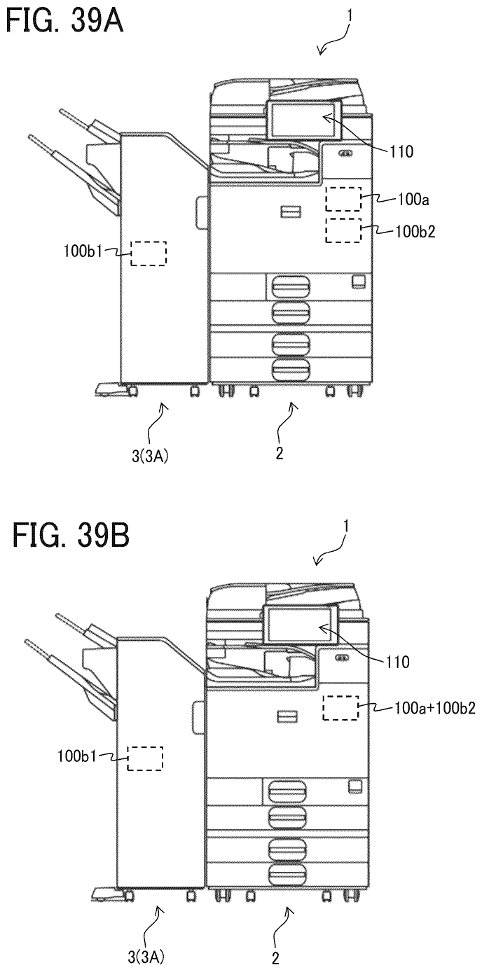

As illustrated in FIG. 39A, the controller 100b of the post-processing apparatus 3 may be divided into, for example, a controller 100b1 that controls a drive unit system such as a motor and a controller 100b2 that controls a detection unit system such as a sensor, in other words, for each function. Among the divided controllers 100b1 and 100b2, for example, only the controller 100b2 of one of the post-processing apparatuses 3A may be provided on the image forming apparatus 2 side. Further, as illustrated in FIG. 39B, the controller 100b2 of the post-processing apparatus 3 disposed in the image forming apparatus 2 may be integrated with the controller 100a of the image forming apparatus 2.

### Second Embodiment of Post-Processing Apparatus

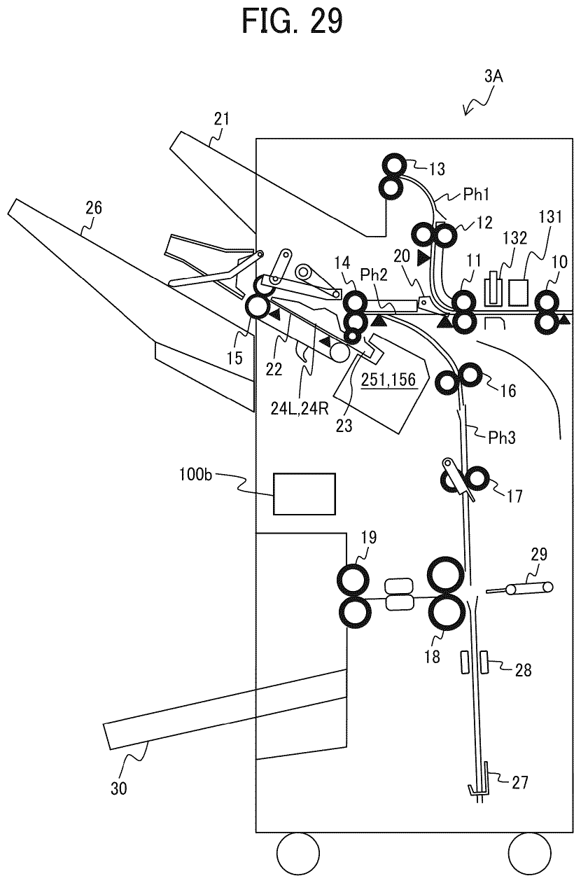

The post-processing apparatus 3A according to the second embodiment is described with reference to FIGS. 29 to 37. Components common to those of the post-processing apparatus 3 according to the first embodiment are attached with the same or like reference signs, and detailed descriptions may be omitted.

The post-processing apparatus 3A according to the second embodiment includes an edge binder 251. The edge binder 251 is different from the edge binder 25 of the post-processing apparatus 3 according to the first embodiment in which the liquid applier 31 and the crimper 32 are arranged side by side. The edge binder 251 includes a crimper 32′ and a liquid applier 131 is disposed at an upstream position in a direction in which the sheet P is conveyed in a conveyance passage. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P, in other words, the width direction of the sheet P is defined as the “main scanning direction”. A liquid application position at which liquid is applied on the sheet P or the sheet bundle Pb by the liquid applier 131 corresponds to a binding position on the sheet bundle Pb to be crimped and bound by the crimper 32′. For this reason, in the following description, the liquid application position and the binding position are denoted by the same reference sign (B1).

FIG. 29 is a diagram illustrating an internal configuration of the post-processing apparatus 3A according to the second embodiment.

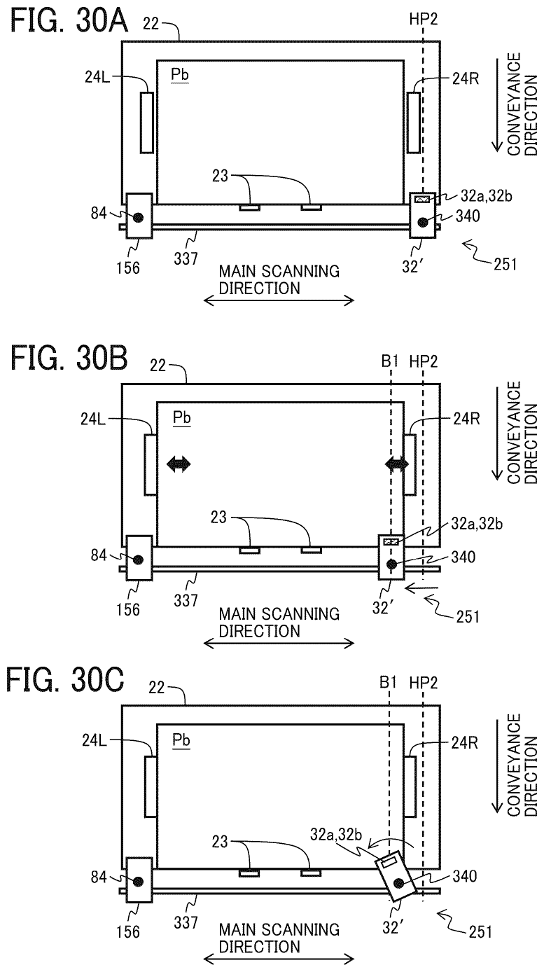

As illustrated in FIGS. 30A to 30C, the edge binder 251 includes the crimper 32′. As illustrated in FIGS. 30A to 30C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and are movable in the main scanning direction.

Further, the crimper 32′ and the staple binder 156 are respectively rotatable in the forward and reverse directions about a crimper rotary shaft 340 and a stapler shaft 84 both extending in the thickness direction of the sheet bundle Pb placed on the internal tray 22. In other words, the crimper 32′ and the staple binder 156 bind, at any desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimp binding”. In other words, the crimper 32′ crimps and binds the sheet bundle Pb or performs the crimp binding on the sheet bundle Pb.

On the other hand, the staple binder 156 passes the staple through a binding position on the sheet bundle Pb placed on the internal tray 22 to staple the sheet bundle Pb.

FIGS. 30A, 30B, and 30C are schematic views of the internal tray 22 as viewed from the thickness direction of the sheet bundle Pb.

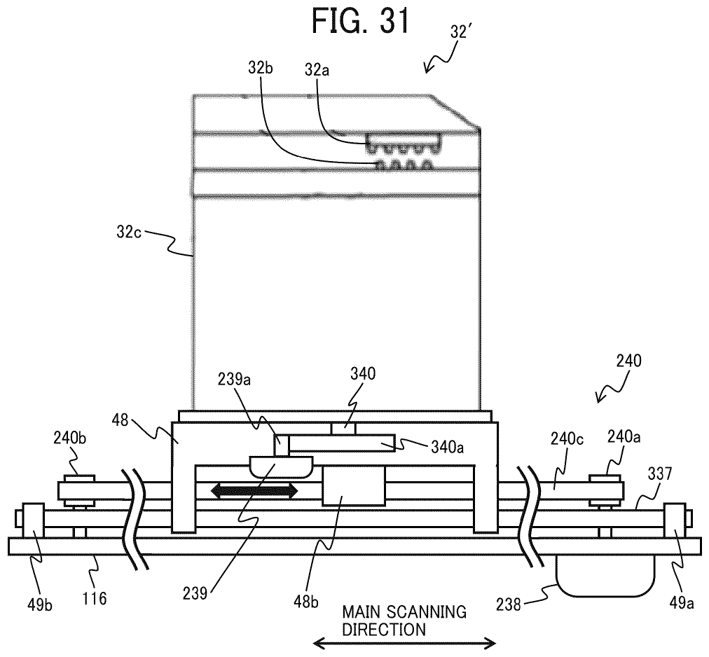

FIG. 31 is a schematic view illustrating a downstream side of the crimper 32′ in the conveyance direction.

As illustrated in FIGS. 30A to 30C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper rotary shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in the thickness direction of the sheet bundle Pb. Since the other components of the staple binder 156 are similar to those of the staple binder 155 (see FIG. 9) of the post-processing apparatus 3 according to the first embodiment, a detailed description thereof is omitted.

As illustrated in FIG. 31, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pulleys 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper rotary shaft 340 including a drive transmission gear 340a is fixed to a bottom face of the crimping frame 32c that holds the components of the crimper 32′.

The crimper rotary shaft 340 and the drive transmission gear 340a are held by a base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper rotary shaft 340 via the output gear 239a and the drive transmission gear 340a, the crimper 32′ rotates in the forward and reverse directions on the base 48 about the crimper rotary shaft 340 extending in the thickness direction of the sheet P placed on the internal tray 22. The guide rail 337, the crimper movement motor 238, the crimper pivot motor 239, the crimper rotary shaft 340, and the drive transmission assembly 240 constitute at least part of an example of a driving assembly of the crimper 32′.

The crimper 32′ is movable between a standby position HP2 illustrated in FIG. 30A and a position where the crimper 32′ faces the first binding position B1 illustrated in FIGS. 30B and 30C. The standby position HP2 is a position deviated to one side in the main scanning direction from the sheet bundle Pb stacked on the internal tray 22. The first binding position B1 is a position on the sheet bundle Pb placed on the internal tray 22. However, the specific position of the first binding position B1 is not limited to the example of FIGS. 30A, 30B, and 30C, and the first binding position B1 may be any one or more positions in the main scanning direction in a downstream end in the conveyance direction of the sheet P.

The posture of the crimper 32′ changes between the parallel binding posture illustrated in FIG. 30B and the oblique binding posture illustrated in FIG. 30C. In other words, the crimper 32′ is rotatable in the forward and reverse directions about the crimper rotary shaft 340. The parallel binding posture is a posture of the crimper 32′ in which the longitudinal direction of the upper crimping teeth 32a and the lower crimping teeth 32b is along the main scanning direction. In other words, the posture of the crimper 32′ is such that the longitudinal direction of a “rectangular crimp binding mark” is along the main scanning direction. The oblique binding posture is a posture of the crimper 32′ in which the longitudinal direction of the upper crimping teeth 32a and the lower crimping teeth 32b is inclined with respect to the main scanning direction. In other words, the posture of the crimper 32′ is such that the longitudinal direction of a “rectangular crimp binding mark” is inclined with respect to the main scanning direction.

The rotation angle in the oblique binding posture, in other words, the angle of the upper crimping teeth 32a and the lower crimping teeth 32b with respect to the main scanning direction is not limited to the example of FIG. 30C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132 as a processor. The liquid applier 131 and the hole punch 132 are disposed upstream from the internal tray 22 in the reverse conveyance direction. In addition, the liquid applier 131 and the hole punch 132 are disposed at different positions in the opposite conveyance direction to simultaneously face one sheet P that is conveyed by the conveyance roller pairs 10 to 19.

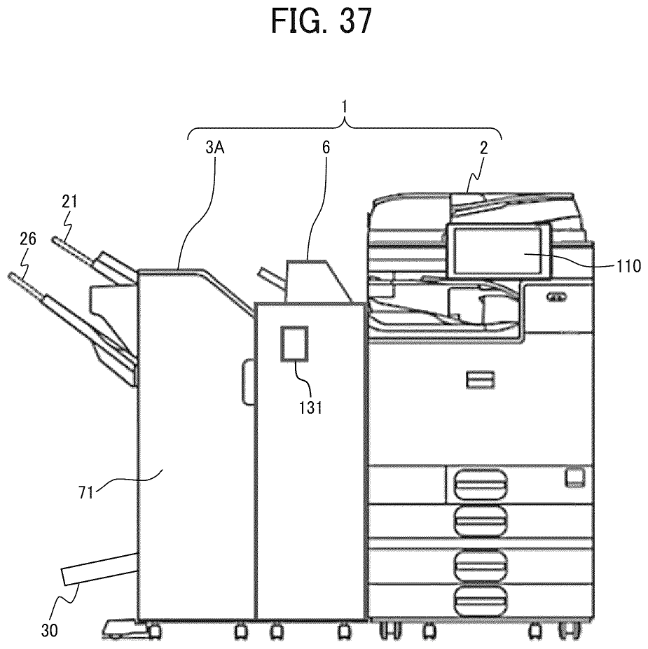

The liquid applier 131 and the hole punch 132 according to the present embodiment are disposed between the conveyance roller pair 10 and the conveyance roller pair 11. However, the arrangement of the liquid applier 131 is not limited to the example of FIG. 29. For example, in a case where an inserter 6 is disposed between the image forming apparatus 2 and the post-processing apparatus 3A as illustrated in FIG. 37, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

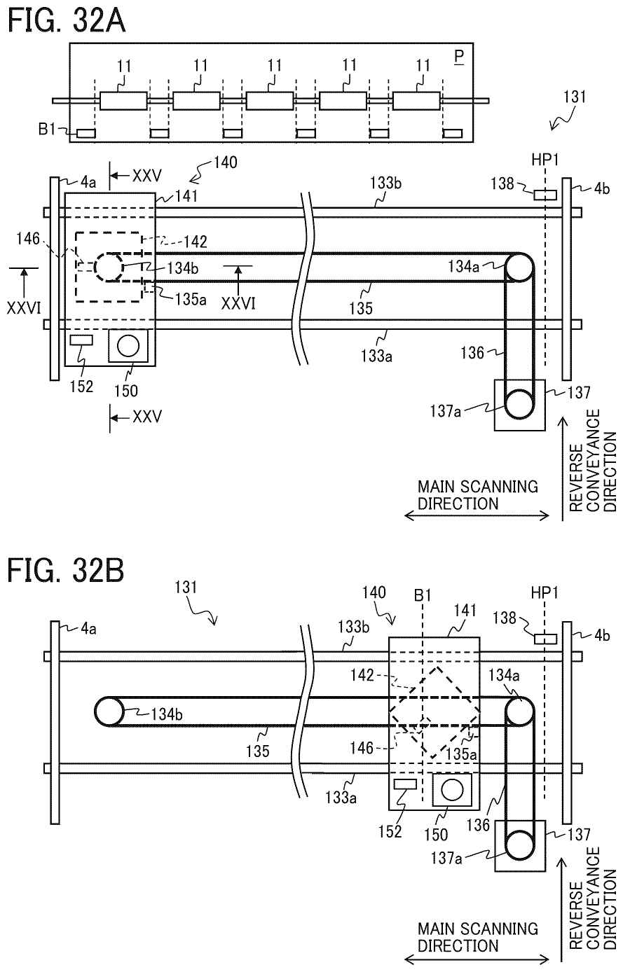

As illustrated in FIG. 32A, the conveyance roller pair 11 is arranged at a position not overlapping, in the main scanning direction, the first liquid application position B1 on the sheet P to which the liquid is applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, multiple of paired rollers included in the conveyance roller pair 11 is located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs included in the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pair 10 and the conveyance roller pair 11 (denoted as “liquid application”). The hole punch 132 punches a hole in the sheet P that is conveyed by the conveyance roller pair 10 and the conveyance roller pair 11 such that the hole passes through the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pair 10 and the conveyance roller pair 11.

FIGS. 32A and 32B are views of the liquid applier 131 in the thickness direction of the sheet P, according to the second embodiment.

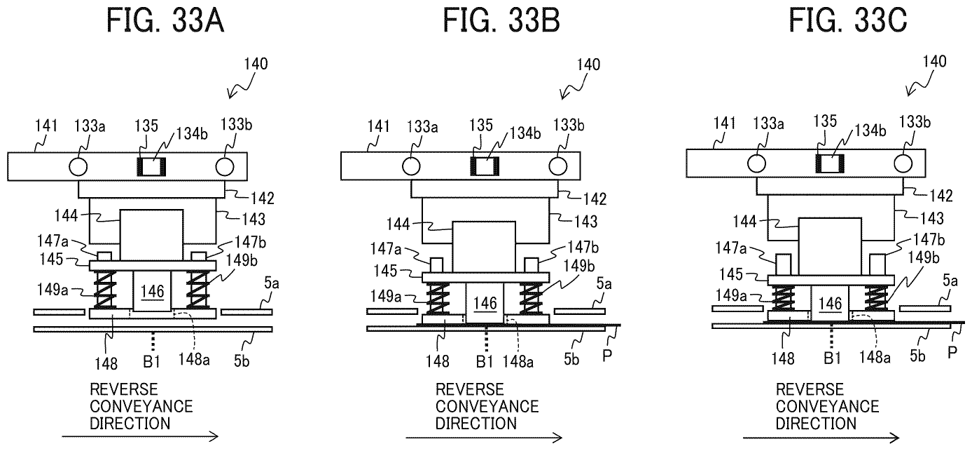

FIGS. 33A, 33B, and 33C are views taken along line XXV-XXV in FIG. 32A.

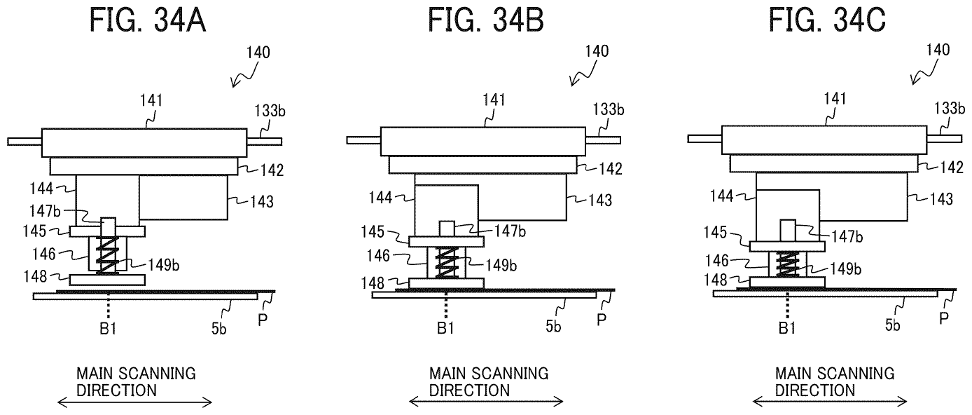

FIGS. 34A, 34B, and 34C are views taken along line XXVI-XXVI in FIG. 32A.

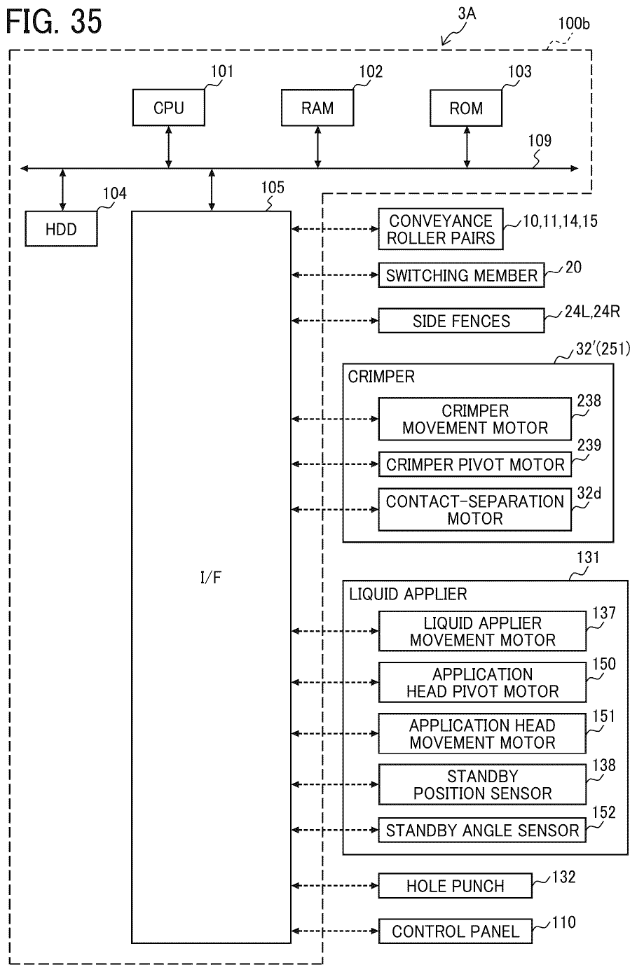

As illustrated in FIGS. 32A to 34C, the liquid applier 131 includes a pair of guide shafts 133a and 133b, a pair of pulleys 134a and 134b, endless annular belts 135 and 136, a liquid applier movement motor 137, a standby position sensor 138, which is also illustrated in FIG. 35, and the liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the pair of guide shafts 133a and 133b in the opposite conveyance direction. The pair of pulleys 134a and 134b is spaced apart from each other in the main scanning direction. The pair of pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a coupling portion 135a. The endless annular belt 136 is looped around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid applier movement motor 137 being switched.

The standby position sensor 138 detects that the liquid application unit 140 has reached a standby position HP1 (see FIGS. 32A and 32B) in the main scanning direction. The standby position sensor 138 then outputs a standby position signal indicating the detection result to the controller 100b, which will be described below with reference to FIG. 35. The standby position sensor 138 is, for example, an optical sensor including a light emitter and a light receiver. At the standby position HP1, the liquid application unit 140 blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 33A, 33B, and 33C, the conveyance passage inside the post-processing apparatus 3A is defined by an upper guide plate 5a and a lower guide plate 5b, which are spaced apart from each other in the thickness direction of the sheet P. The liquid application unit 140 is located to face an opening of the upper guide plate 5a. In other words, the liquid application unit 140 is disposed to face the sheet P conveyed on the conveyance passage through the opening of the upper guide plate 5a.

As illustrated in FIGS. 32A to 34C, the liquid application unit 140 includes a base 141, a rotary bracket 142, a liquid storage tank 143, a liquid application head mover 144, a holder 145, the liquid application head 146, columns 147a and 147b, a pressure plate 148, coil springs 149a and 149b, the application head pivot motor 150, the application head movement motor 151 (see FIG. 35), and a standby angle sensor 152 (see FIG. 35).

The base 141 is supported by the pair of guide shafts 133a and 133b so as to be slidable in the main scanning direction. The base 141 is coupled to the endless annular belt 135 by the coupling portion 135a. The base 141 supports the components (for example, the rotary bracket 142, the liquid storage tank 143, the liquid application head mover 144, the holder 145, the liquid application head 146, the columns 147a and 147b, the pressure plate 148, and the coil springs 149a and 149b, the application head pivot motor 150, the application head movement motor 151, and the standby angle sensor 152) of the liquid application unit 140.

The rotary bracket 142 is attached to the lower face of the base 141 so as to be rotatable in the forward and reverse directions about an axis extending in the thickness direction of the sheet P. The rotary bracket 142 is rotated in the forward and reverse directions with respect to the base 141 by a driving force transmitted from the application head pivot motor 150. The rotary bracket 142 retains the liquid storage tank 143, the liquid application head mover 144, the holder 145, the liquid application head 146, the columns 147a and 147b, the pressure plate 148, and the coil springs 149a and 149b.

The standby angle sensor 152, which is also illustrated in FIG. 35, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 32A illustrates the rotary bracket 142 in a position for the parallel binding that is performed by the crimper 32′ disposed downstream from the liquid applier 131 in a direction in which the sheet P is conveyed.

FIG. 32B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid application head mover 144 is attached to the liquid storage tank 143 so as to be movable (e.g., up and down) in the thickness direction of the sheet P. The liquid application head mover 144 moves in the thickness direction of the sheet P with respect to the liquid storage tank 143 by a driving force transmitted from the application head movement motor 151. The holder 145 is attached to a lower end of the liquid application head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b hold the pressure plate 148 at lower ends thereof. The pressure plate 148 has a through hole 148a at a position where the through hole 148a faces the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 in a direction away from the holder 145.

As illustrated in FIGS. 33A and 34A, before the sheet P is conveyed to the position where the sheet P faces the opening of the upper guide plate 5a, the pressure plate 148 is positioned at or above the opening. Subsequently, when the sheet P that is conveyed by the conveyance roller pair 10 and the conveyance roller pair 11 stops at a position where the first liquid application position B1 on the sheet P faces the opening, the application head movement motor 151 is rotated in a first direction. As a result, the liquid application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 is a position to be crimped and bound by the crimper 32′ included in the edge binder 251, in other words, the first binding position B1.

As the application head movement motor 151 keeps rotating in the first direction after the pressure plate 148 contacts the sheet P, the coil springs 149a and 149b are compressed to further move down the liquid application head mover 144, the holder 145, the liquid application head 146, and the columns 147a and 147b. As a result, as illustrated in FIGS. 33B and 34B, the lower face of the liquid application head 146 contacts the sheet P through the through hole 148a. As a result, the liquid contained in the liquid application head 146 is applied to the sheet P.

Further rotation of the application head movement motor 151 in the first direction further strongly presses the liquid application head 146 against the sheet P as illustrated in FIGS. 33C and 34C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the application head movement motor 151 in the second direction opposite to the first direction moves up the liquid application head mover 144, the holder 145, the liquid application head 146, the columns 147a and 147b, the pressure plate 148, and the coil springs 149a and 149b together. As a result, as illustrated in FIGS. 33A and 34A, the liquid application head 146 and the pressure plate 148 are separated from the sheet P. In other words, the liquid applier 131 includes the liquid application head 146 that can be separated from the sheet P.

FIG. 35 is a hardware configuration diagram of a control block of the post-processing apparatus 3A according to the second embodiment.

As illustrated in FIG. 35, the post-processing apparatus 3A includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3A.

The RAM 102 is a volatile storage medium that allows high speed reading and writing of data, and is used as a working area when the CPU 101 processes information.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b serving as a controller or circuitry that controls the operation of the post-processing apparatus 3A.

The I/F 105 is an interface that connects the conveyance roller pairs 10, 11, 14, and 15, the switcher 20, the side fences 24L and 24R, the crimper movement motor 238, the crimper pivot motor 239, a contact-separation motor 32d, a liquid applier movement motor 137, an application head pivot motor 150, an application head movement motor 151, a standby position sensor 138, a standby angle sensor 152, a hole punch 132, and an operation panel 110 to the common bus 109.

The controller 100 b controls, via the I/F 105, the operations of the conveyance roller pairs 10, 11, 14, and 15, the switcher 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 35 mainly illustrates the components of the edge binder 251 and the liquid applier 131 including the crimper 32′ that executes the edge binding process, the components of the saddle binder 28 that executes the saddle binding process are controlled by the controller 100b like the components of the liquid applier 131 and the edge binder 251 (the crimper 32′) that executes the edge binding.

As illustrated in FIG. 37, the image forming apparatus 2 includes the operation panel 110. The operation panel 110 includes an operation unit that receives instructions from a user and a display serving as a notifier that notifies the user of information. The operation unit includes, for example, physical input buttons and a touch panel overlaid on a display. The operation panel 110 acquires information from the user through the operation unit and provides the information to the user through the display. The notifier is not limited to the display and may be a light-emitting diode (LED) lamp or a speaker. The post-processing apparatus 3A may include an operation panel 110 similar to the above-described operation panel 110 of the image forming apparatus 2.

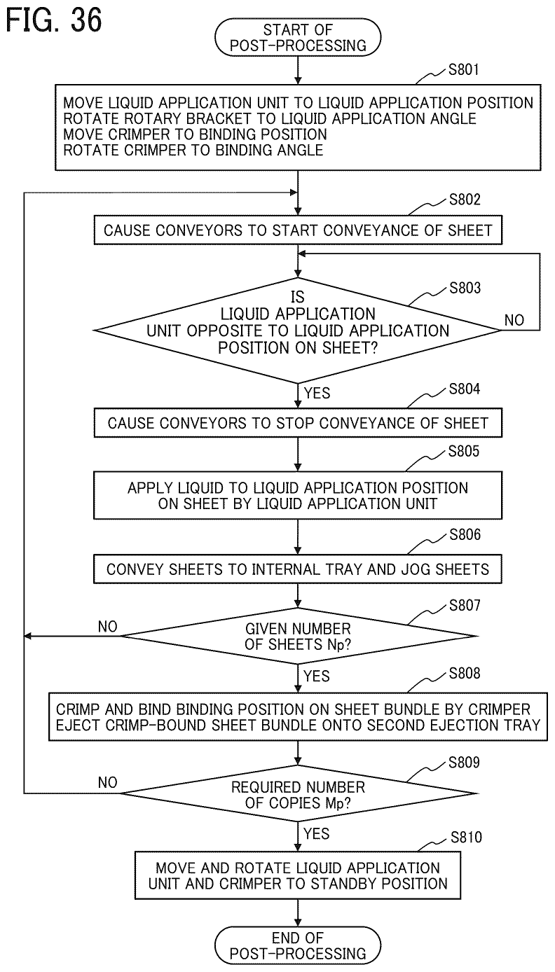

FIG. 36 is a flowchart of post-processing of the post-processing apparatus 3A according to the second embodiment. Specifically, FIG. 36 is a flowchart of a process in executing the one-point binding process illustrated in FIGS. 30A to 30C.

For example, the controller 100b executes the post-processing illustrated in FIG. 36 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of copies Mp”), the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (punching a hole in the present embodiment). At the start of the post-processing, the liquid application unit 140 is at the standby position HP1 illustrated in FIGS. 32A and 32B, and the rotary bracket 142 is held at the standby angle (corresponding to the parallel binding posture) at the standby position HP1.

First, the controller 100b drives the liquid applier movement motor 137 to move the liquid application unit 140 (corresponding to a liquid application device) in the main scanning direction, thus causing the liquid application head 146 to move from the standby position HP1 to the position where the liquid application head 146 can face the first liquid application position B1 (see FIG. 32B, the position corresponding to the first binding position B1 illustrated in FIG. 30B and FIG. 30C). If the type of the binding process instructed by the post-processing command is “oblique binding process”, in step S801, the controller 100b drives the application head pivot motor 150 to rotate the rotary bracket 142. Thus, the liquid application head 146 is rotated from the standby angle to the liquid application angle corresponding to the “oblique binding posture”. It can be ascertained, based on pulse signals output from rotary encoders of the liquid applier movement motor 137 and the application head pivot motor 150, that the liquid application head 146 has reached the position where the liquid application head 146 can face the first liquid application position B1. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the first binding position B1 as illustrated in FIGS. 30A and 30B. Alternatively, if the type of the binding process instructed by the post-processing command is “oblique binding process”, in step S801, the controller 100b drives the crimper pivot motor 239 to rotate the crimper 32′ from the standby angle to the crimping angle corresponding to the “oblique binding posture”. It is ascertained based on a pulse signal output from a rotary encoder of the crimper movement motor 238 that the crimper 32′ has reached the position where the crimper 32′ can face the first binding position B1. Similarly, it is ascertained based on a pulse signal output from a rotary encoder of the crimper pivot motor 239 that the crimper 32′ has reached the crimping angle. If the type of the binding process instructed by the post-processing command is “parallel binding process”, the controller 100b omits the above-described operation of rotating the crimper 32′. In other words, the crimper 32′ moves in the main scanning direction while maintaining the standby angle.

Subsequently, in step S802, the controller 100b drives the conveyance roller pair 10 and the conveyance roller pair 11 to start conveying the sheet P on which an image is formed by the image forming apparatus 2. The controller 100b determines whether the first liquid application position B1 on the sheet P has faced the liquid application unit 140 (more particularly, the liquid application head 146) (step S803). When the controller 100b determines that the first liquid application position B1 on the sheet P has not faced the liquid application unit 140 (No in S803), the controller 100b continues causing the conveyance roller pair 10 and the conveyance roller pair 11 to convey the sheet P until the first liquid application position B1 on the sheet P faces the liquid application unit 140 (Yes in S803). When the controller 100b determines that the first liquid application position B1 on the sheet P has faced the liquid application head 146 (Yes in step S803), in step S804, the controller 100b causes the conveyance roller pair 10 and the conveyance roller pair 11 to stop conveying the sheet P. It can be ascertained, based on a pulse signal output from a rotary encoder of a motor that drives the conveyance roller pair 10 and the conveyance roller pair 11, that the first liquid application position B1 on the sheet P has faced the liquid application head 146.

The controller 100b causes the liquid application unit 140 to execute the process of applying liquid to the first liquid application position B1 on the sheet P (step S805). More particularly, the controller 100b rotates the application head movement motor 151 in the first direction to bring the liquid application head 146 into contact with the first liquid application position B1 on the sheet P. The controller 100b changes the pressing force of the liquid application head 146, in other words, the amount of rotation or rotation speed of the application head movement motor 151 depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed below. The amount of rotation of the application head movement motor 151 may be ascertained based on a pulse signal outputted from a rotary encoder of the application head movement motor 151.

The controller 100b drives the conveyance roller pairs 10, 11, 14, and 15 to place a sheet P on the internal tray 22 (step S806). In addition, the controller 100b reciprocates the side fences 24L and 24R in the main scanning direction to align the positions in the main scanning direction of the sheet P or the sheet bundle Pb stacked on the internal tray 22, in other words, execute so-called jogging process (step S806).

The controller 100b determines whether the number of sheets P placed on the internal tray 22 has reached the given number of sheets Np indicated by the post-processing command (step S807). When the controller 100b determines that the number of sheets P placed on the internal tray 22 has not reached the given number of sheets Np (No in step S807), the controller 100b executes the operations of steps S802 to S807 again until the number of sheets P placed on the internal tray 22 reaches the given number of sheets Np (Yes in step S807).

By contrast, when the controller 100b determines that the number of sheets P that are placed on the internal tray 22 has reached the given number of sheets Np (Yes in step S807), in step S808, the controller 100b causes the crimper 32′ to crimp the first binding position B1 (corresponding to the first liquid application position B1 of the sheet P) on the sheet bundle Pb including the sheet P to which the liquid has been applied by the liquid application unit 140. Further, the controller 100b also rotates the conveyance roller pair 15 to eject the crimped and bound sheet bundle Pb to the second ejection tray 26 (step S808).

The controller 100b determines whether the number of sheet bundles Pb thus ejected to the second ejection tray 26 has reached the requested number of copies Mp indicated by the post-processing command (step S809). When the controller 100b determines that the number of the sheet bundles Pb ejected to the ejection tray 26 has not reached the requested number of copies Mp (No in step S809), the controller 100b repeats the processing of steps S802 to S809 until the number of the sheet bundles Pb ejected to the ejection tray 26 reaches the requested number of copies Mp (Yes in step S809).

When the controller 100b determines that the number of sheet bundles Pb ejected to the second ejection tray 26 reaches the requested number of copies Mp (Yes in step S809), in step S810, the controller 100b drives the liquid applier movement motor 137 to move the liquid application unit 140 to the standby position HP1 (see FIG. 32B) and drives the crimper movement motor 238 to move the crimper 32′ to the standby position HP2 (see FIG. 30A). When the posture that is instructed by the post-processing command is the “oblique binding posture”, the controller 100b drives the application head pivot motor 150 and the crimper pivot motor 239 to rotate the liquid application unit 140 and the crimper 32′ and the parallel binding posture (corresponding to the standby angle) into the parallel binding posture (step S810). By contrast, when the posture that is instructed by the post-processing command is the “parallel binding posture”, the controller 100b skips the aforementioned operation of rotating the liquid application unit 140 and the crimper 32′ to the parallel binding posture (corresponding to the standby angle). In steps S801 and S810, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge binding process as described above. However, the embodiments of the present disclosure may be applied to the saddle binder 28 that executes the saddle binding.

The configuration in which the controller 100b of the post-processing apparatus 3A according to the second embodiment illustrated in FIG. 29 is provided separately from the controller 100a of the image forming apparatus 2 similarly with FIG. 1 has been described, but it is not limited to such a configuration. For example, as illustrated in FIG. 38A, the controller 100b of the post-processing apparatus 3A may be disposed in the image forming apparatus 2. Further, as in the configuration of FIG. 38B, the controller 100b of the post-processing apparatus 3A may be integrated with the controller 100a of the image forming apparatus 2.

Similarly to FIG. 39A, the controller 100b of the post-processing apparatus 3A may be divided into, for example, a controller 100b1 that controls a drive unit system such as a motor and a controller 100b2 that controls a detection unit system such as a sensor, in other words, for each function. Among the divided controllers 100b1 and 100b2, for example, only the controller 100b2 of one of the post-processing apparatuses 3A may be provided on the image forming apparatus 2 side. Further, as in the configuration of FIG. 39B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a controller or circuitry to operate in cooperation with each other based on a program. In addition, the program may be written in, for example, a storage device or a storage medium and distributed, or may be distributed through, for example, an electric communication line.

### ASPECTS

Aspects of the present disclosure are, for example, as follows.

### Aspect 1

In Aspect 1, a medium processing apparatus includes a crimper, and a control device. The crimper performs crimp binding to press and deform a part of a media bundle obtained by bundling multiple media with a pair of opposing crimping teeth. The control device moves the crimper to a predetermined binding position and performs an operation of crimp binding. The crimper includes a remover that peels off a medium adhered to one of the crimping teeth. The control device is to execute a first removing operation by the remover, and a second removing operation of removing the medium attached to the remover.

### Aspect 2

In Aspect 2, in the medium processing apparatus according to Aspect 1, the first removing operation is performed by an operation of separating the other crimping tooth from the one crimping tooth in the operation of the crimp binding. The second removing operation is performed by an operation of shifting a relative position between the crimper and the binding position.

### Aspect 3

In Aspect 3, in the medium processing apparatus according to Aspect 1 or 2, the control device is to move, in the second removing operation, the crimper from a binding position after the crimp binding is performed.

### Aspect 4

In Aspect 4, the medium processing apparatus according to Aspect 1 or 2 further includes an aligner that aligns ends of the multiple media. The control device is to perform an alignment operation by the aligner before performing the operation of the crimp binding, and move, in the second removing operation, the aligner to shift a relative position between the media bundle and the crimper after the crimp binding is performed.

### Aspect 5

In Aspect 5, in the medium processing apparatus according to any one of Aspect 1 to 4, the control device is to simultaneously operate the first removing operation and the second removing operation.

### Aspect 6

In Aspect 6, in the medium processing apparatus according to any one of Aspects 1 to 5, the remover is positioned between the one crimping tooth and the other crimping tooth when the one crimping tooth and the other crimping tooth press and deform the media bundle, and moves, when the other crimping tooth is separated from the one crimping tooth in the operation of the crimper, to a position separated from the one crimping tooth.

### Aspect 7

In Aspect 7, in the medium processing apparatus according to any one of Aspects 1 to 6, the remover includes a contact portion that comes in contact with the media bundle. The contact portion has a slit.

### Aspect 8

In Aspect 8, in the medium processing apparatus according to any one of Aspects 1 to 6, the remover includes a contact portion that comes in contact with the media bundle. The contact portion has a shape that discontinuously contacts the media bundle.

### Aspect 9

In Aspect 9, an image forming system includes an image forming apparatus that forms an image on the medium, and the medium processing apparatus according to any one of Aspects 1 to 8 that crimps and binds the multiple media on which images are formed by the image forming apparatus.

### Aspect 10

In Aspect 10, a medium processing apparatus includes a crimper and circuitry. The crimper includes a crimping teeth pair and a remover. The crimping teeth pair faces each other to press and deform a part of a media bundle bundling multiple media including a medium to perform a crimp-binding operation. The remover removes the medium attached to one of the crimping teeth pair. The circuitry is to move the crimper to a binding position in a scanning direction to perform the crimp-binding operation, control the remover to remove the medium from the one of the crimping teeth pair to perform a first removing operation, and control the crimper to remove the medium attached to the remover to perform a second removing operation.

### Aspect 11

In Aspect 11, in the medium processing apparatus according to Aspect 10, the circuitry is further to control the remover to separate the one of the crimping teeth pair from another of the crimping teeth pair in the crimp-binding operation to perform the first removing operation, and control the crimper to shift relative positions between the crimper and the media bundle from the binding position in the scanning direction to perform the second removing operation.

### Aspect 12

In Aspect 12, in the medium processing apparatus according to Aspect 10 or 11, the circuitry is further to move the crimper from the binding position in the scanning direction, after performing the crimp-binding operation on the media bundle, in the second removing operation.

### Aspect 13

In Aspect 13, the medium processing apparatus according to Aspect 10 or 11 further includes

### Aspect 14

In Aspect 14, the medium processing apparatus according to any one of Aspects 10 to 13 further includes an aligner to align ends of the multiple media in the scanning direction to perform an alignment operation. The circuitry is further to control the aligner to perform the alignment operation before performing the crimp-binding operation, and move the aligner to shift the relative positions, after preforming the crimp-binding operation, in the second removing operation.

### Aspect 15

In Aspect 15, in the medium processing apparatus according to any one of Aspects 10 to 14, the remover is positioned between the crimping teeth pair when the crimping teeth pair deform the media bundle. The circuitry is further to move the remover to a position separated from the one of the crimping teeth pair. When said another of the crimping teeth pair is separated from the one of the crimping teeth pair in the crimp-binding operation.

### Aspect 16

In Aspect 16, in the medium processing apparatus according to any one of Aspects 10 to 15, the remover includes a contact portion to contact the media bundle. The contact portion has a slit.

### Aspect 17

In Aspect 17, in the medium processing apparatus according to any one of Aspects 10 to 15, the remover includes a contact portion to contact the media bundle. The contact portion has a shape that discontinuously contacts the media bundle.

### Aspect 18

In Aspect 18, in the medium processing apparatus according to any one of Aspects 10 to 18, the remover includes a contact portion to contact the media bundle. The contact portion has a removing hole in a portion overlapping with the one of the crimping teeth pair. The one of the crimping teeth pair penetrates through the removing hole and protrudes from the removing hole toward said another of the crimping teeth pair in the first removing operation.

### Aspect 19

In Aspect 19, an image forming system including an image forming apparatus to form an image on a medium of multiple media, and the medium processing apparatus to perform the crimp-binding operation on the multiple media having the image formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a crimper including:
a crimping teeth pair facing each other to press and deform a part of a media bundle bundling multiple media including a medium to perform a crimp-binding operation; and
a remover to remove the medium attached to one of the crimping teeth pair; and
circuitry configured to:
move the crimper to a binding position in a scanning direction to perform the crimp-binding operation; and
control the remover to remove the medium from the one of the crimping teeth pair to perform a first removing operation; and
control the crimper to remove the medium attached to the remover to perform a second removing operation.

2. The medium processing apparatus according to claim 1,
wherein the circuitry is further configured to:
control the remover to separate the one of the crimping teeth pair from another of the crimping teeth pair in the crimp-binding operation to perform the first removing operation; and
control the crimper to shift relative positions between the crimper and the media bundle from the binding position in the scanning direction to perform the second removing operation.

3. The medium processing apparatus according to claim 2,
wherein the circuitry is further configured to:
move the crimper from the binding position in the scanning direction, after performing the crimp-binding operation on the media bundle, in the second removing operation.

4. The medium processing apparatus according to claim 2, further comprising:
an aligner to align ends of the multiple media in the scanning direction to perform an alignment operation,
wherein the circuitry is further configured to:
control the aligner to perform the alignment operation before performing the crimp-binding operation; and
move the aligner to shift the relative positions, after preforming the crimp-binding operation, in the second removing operation.

5. The medium processing apparatus according to claim 1,
wherein the circuitry is further configured to simultaneously perform the first removing operation and the second removing operation.

6. The medium processing apparatus according to claim 1,
wherein the remover is positioned between the crimping teeth pair when the crimping teeth pair deform the media bundle, and
the circuitry is further configured to move the remover to a position separated from the one of the crimping teeth pair,
when said another of the crimping teeth pair is separated from the one of the crimping teeth pair in the crimp-binding operation.

7. The medium processing apparatus according to claim 1,
wherein the remover includes a contact portion to contact the media bundle, and
the contact portion has a slit.

8. The medium processing apparatus according to claim 1,
wherein the remover includes a contact portion to contact the media bundle, and
the contact portion has a shape that discontinuously contacts the media bundle.

9. The medium processing apparatus according to claim 1,
wherein the remover includes a contact portion to contact the media bundle,
the contact portion has a removing hole in a portion overlapping with the one of the crimping teeth pair, and
the one of the crimping teeth pair penetrates through the removing hole and protrudes from the removing hole toward said another of the crimping teeth pair in the first removing operation.

10. An image forming system comprising:
an image forming apparatus to form an image on a medium of multiple media; and
the medium processing apparatus according to claim 1 to perform the crimp-binding operation on the multiple media having the image formed by the image forming apparatus.
